(19) United States
(12) Patent Application Publication
(10) Pub. No.: US 2009/0094647 A1
(43) Pub. Date: Apr. 9, 2009

(54) Node device, recording medium recording process program, information delivery system and recording medium recording server processing program

(75) Inventors: Takuya Inoue, Nagoya-shi (JP); Yuji Kiyohara, Nagoya-shi (JP); Hideki Matsuo, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, Nagoya-Shi (JP)

(21) Appl. No.: 12/292,994

(22) Filed: Dec. 2, 2008

Related U.S. Application Data
(63) Continuation-in-part of application No. PCT/JP2007/066301, filed on Aug. 22, 2007.

(30) Foreign Application Priority Data
Aug. 31, 2006 (JP) 2006-236476

(51) Int. Cl. H04N 5/445

(52) U.S. Cl. 725/55

(57) ABSTRACT

To provide a node device or the like which can view programs broadcasted in past by a simple operation without applying a large load to a specific device such as a server.

A node device included in an information delivery system that includes a plurality of node devices mutually communicable through a network and at least one or more broadcast stations broadcasting program information, the node device including:
a program information receiving means for receiving program information broadcasted respectively from the broadcast stations; and
a program information storage means for storing program information assigned as a record in charge among the program information thus received in correspondence with identification information inherent in the program information so that the program information is shared among the plurality of node devices.

The entire disclosures of Japanese Patent Applications No. 2006-236476 filed on Aug. 31, 2006 including the specification, claims, drawings and summary are incorporated herein by reference in its entirety.

### BACKGROUND OF THE INVENTION

1. Field of the Invention

The present invention relates to a technical field of an information delivery system or the like that has a plurality of node devices mutually communicable through a network and that receives program information broadcasted from a broadcast station through any one of the node devices.

2. Discussion of the Related Art

In recent years, quality of content obtained by recording by individual users TV broadcasting, radio broadcasting and CATV (Cable Television or Community Antenna Television), such as programmed recording of digital broadcasting, hard disc recorder, G code (encoding elements (recording date, recording channel, recording start time, and recording finish time) for timer-controlled recording of programs), and automatic CM (Commercial Message) cutting has been improved Further function to prevent recording failure by keyword recording and the like is also known.

Patent Document 1 discloses a program recording system having plural recording devices recording program data including image and sound of broadcasted programs, a program database device recording program information indicative of at least a broadcast start time and a broadcast finish time of the program with respect to every broadcasted program, and a server device connected to the program database device. In this program recording system, in a case where it fails to start recording program data on broadcast start time in a certain recording device, program data are searched among program data recorded in respective recording devices by the server device for the period from the broadcast start time to the broadcast finish time of necessary programs, and the program data thus searched are acquired and recorded by the recording device which failed to record the program data. Therefore, necessary program data are searched after the broadcast start time among prerecorded program data which are recorded in a single recording device, and the program data can be delivered and received between recording devices.

Further, Patent Document 2 discloses an internet delivery system for broadcast program information of television or radio, that includes a broadcast program redelivery host site for collecting (recording) entire broadcast program information broadcasted and delivered from a broadcast program generation medium and a client information processing device for downloading the broadcast program information from the broadcast program redelivery host site through internet.

### Patent Document 1: Japanese Unexamined Patent Publication No. 2004-320455

### Patent Document 2: Japanese Unexamined Patent Publication No. 2003-101498

### SUMMARY OF THE INVENTION

However, in the program recording system and the internet delivery system as described above, since the server device (or the broadcast program redelivery host site) handles delivery and receipt of program data between recording devices, the server device receives much burden when a number of users of the program recording system increases.

The present invention is provided in consideration of the above problems. An object of the present invention is to provide a node device, a recording medium recording a processing program, and a recording medium recording an information delivery system and a server processing program that enables to view programs broadcasted in the past, by easy operation without applying much burden to the specific devices such as the above-mentioned server device.

To solve the above problem, according to the invention recited in claim 1, there is provided a node device included in an information delivery system that includes a plurality of node devices mutually communicable through a network and at least one or more broadcast stations broadcasting program information, the node device including:

a program information receiving means for receiving program information broadcasted respectively from the broadcast stations; and

a program information storage means for storing program information assigned as a record in charge among the program information thus received in correspondence with identification information inherent in the program information so that the program information is shared among the plurality of node devices.

According to this invention, because the plurality of node devices receiving the program respectively broadcasted from the broadcasting stations is configured to store the programs respectively allocated as a record in charge so as to be shared among the node devices in correspondence with a content ID inherent in the program, it is possible for users respectively of the node devices to acquire, view and listen the program broadcasted in past times from the node nn recording and storing the program without applying a large load to for example a specific server.

According to the present invention, a plurality of node devices receiving programs broadcasted from respective broadcast stations relate programs respectively assigned as a charge of recording with content ID inherent to the program and store them so as to be shared among a plurality of node devices. Therefore, the user of the respective node devices can acquire the programs broadcasted in the past from the node nn recording and storing programs and view them without loading much burden on the specific servers.

### BRIEF DESCRIPTION OF THE DRAWINGS

FIG. 1 is a view showing an example of connection status of respective node devices in a content delivery system according to the present embodiment.

FIG. 2 is a view showing an example of a DHT routing table retained by a node n1.

FIG. 3 is a schematic view showing an example of a node ID space of DHT.

FIG. 4A is a schematic view showing an example of a flow of a publish message sent from the content retention node in the node ID space of the DHT.

FIG. 4B is a schematic view showing an example of a flow of a content location inquiry message and content data acquisition that are sent from the user node in the node ID space of the DHT.

FIG. 5 is a view showing an example of a schematic configuration of a node nn.

FIG. 6 is a view showing an example of a schematic configuration of a registration server 2d.

FIG. 7 is a view showing an example of a schematic configuration of a log server 2c.

FIG. 8 is a view showing an example of a schematic configuration of a settlement server 2f.

FIG. 9 is a view showing an example of a schematic configuration of a library server 2g.

FIG. 10 is a flowchart showing a process in a control unit 11 of the node nn according to the present embodiment.

FIG. 11 is a flowchart showing “registration process” in the node nn.

FIG. 12 is a flowchart showing “registration process” in the node nn.

FIG. 13 is a flowchart showing “recording process” in the node nn.

FIG. 14 is a flowchart showing “delete process” in the node nn.

FIG. 15 is a flowchart showing “log sending process” in the node nn.

FIG. 16 is a flowchart showing “reproduction process” in the node nn.

FIG. 17 is a flowchart showing a process in a control unit 21 of a registration server 2d according to the present embodiment.

FIG. 18 is a flowchart showing a process in a control unit 31 of a log server 2e according to the present embodiment.

FIG. 19 is a flowchart showing a process in a control unit 51 of a library server 2g according to the present embodiment.

### DETAILED DESCRIPTION OF THE PREFERRED EMBODIMENTS

Preferred embodiments of the present invention will be described, wherein each designation of numerical reference in the drawings is typically as follows:
nn: Node
2a, 2b, 2c: Broadcast station;
2d: Registration server;
2e: Log server;
2f: Settlement server;
2g: Library server;
8: Network;
9: Overlay network;
11: Control unit;
12: Memory unit;
13: Buffer memory;
14: Decoder;
15: Image processing unit;
16: Display unit;
17: Audio processing unit;
18: Speaker;
19: Encoder;
19a: Communication unit;
19b: Receiving unit;
19c: Input unit;
19d: Bus;
21: Control unit;
22: Memory unit;
22a: User information database;
23: Communication unit;
24: Bus;
31, 41, 51: Control unit;
32, 42, 52: Memory unit;
33, 43, 53: Communication unit;
34, 44, 54: Bus; and
S: Content delivery system

Hereinafter, embodiments of the present invention will be described in reference of figures. Here, the embodiments described below are embodiments in a case where the present invention is applied to a content delivery system.

### [1. Configuration and the Like of Content Delivery System]

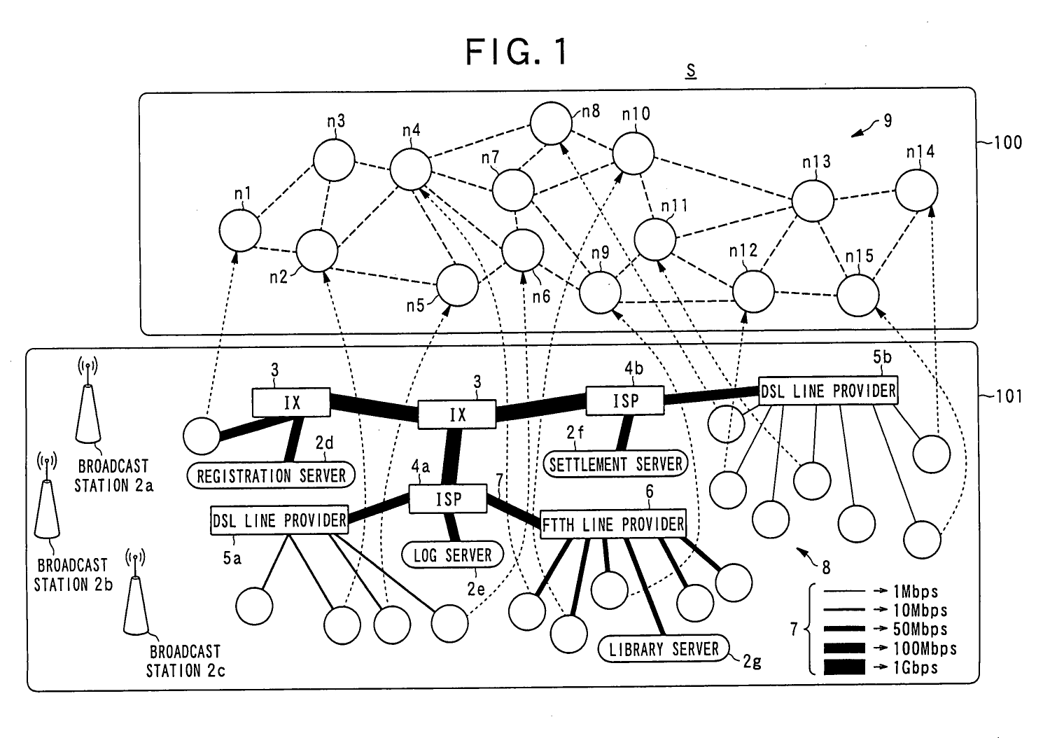

First, with reference to FIG. 1, a schematic configuration and the like of a content delivery system as an example of the content delivery system are described.

FIG. 1 is a view showing an example of connection status of respective node devices in a content delivery system according to the present embodiment.

As shown in a lower frame 101 in FIG. 1, a network (communication network in real world) 8 of the Internet or the like is constructed by an internet exchange (IX) 3, internet service providers (ISP) 4a, 4b, digital subscriber line (DSL) providers (or device thereof) 5a, 5b, fiber to the home (FTTH) line provider (or device thereof) 6, and communication line (e.g. a phone line or an optical cable) 7 or the like. Here, in the network (a communication network in real world) 8 of the example of FIG. 1, a router for transferring data (packet) is appropriately inserted but not shown in the figures.

The content delivery system S is provided with a plurality of node devices (hereinafter referred to as “nodes”) n1, n2 . . . n21 that are mutually connected through such the network 8, and the system is a peer-to-peer type network system (actually, there are more nodes existing). Further, an inherent manufacturing number and an IP (Internet Protocol) address are assigned to each of the nodes n1 to n21. Such manufacturing numbers and IP addresses do not overlap among a plurality of nodes.

These nodes n1 to n21 are an STB (Set Top Box) or the like exclusively used for a dedicated service, such as CATV (Cable Television or Community Antenna Television) are enabled to record (store) program information (hereinafter referred to as “content data”) having program data (CM information and the like being incorporated in the program in some cases) including images and sounds in the program broadcasted through various broadcast channels from broadcast stations 2a, 2b, 2c in domestic or overseas. As broadcast media broadcasting the content data from the broadcast stations 2a, 2b, 2c, dedicated lines including satellite radio wave, ground wave, internet, CATV cable are applicable.

A registration server 2d manages participation and registration in the content delivery system S of the node nn. Further, a log server 2e manages availability of the system S of respective nodes nn, and a settlement server 2f carries out an accounting process for secondary use of content data to respective nodes nn in response to the availability. A library server 2g collects and manages content data recorded in respective nodes nn.

Then, in the content delivery systems, an overlay network 9 is configured by a specific algorithm, for example, an algorithm using DHT (Distributed Hash Table) as shown in an upper frame 100 of FIG. 1. This overlay network 9 means a network (logical network) configuring a virtual link formed by use of an existing network 8.

The present embodiment is on a premise of an overlay network 9 configured by an algorithm using DHT, and nodes n1 to n15 assigned to this overlay network 9 (in the upper frame 100 in FIG. 1) are referred to as nodes nn participating in the overlay network 9. In other words, the overlay network 9 is formed by participation of the node nn.

Such the participation into the overlay network 9 is done when nodes n16 to n21 (not participating in the overlay network 9 at this stage) sending user information to the registration server 2d and appropriately registered in the content delivery system S send a participation message indicative of participation request to an arbitrary participating node nn. Then, when the node registration is done in the registration server 2d receiving user information, the node n16 trying to newly register accesses to arbitrary node nn already participating and copies DHT (described later) from the arbitrary node nn sending the participation message and participating.

The respective nodes nn have a node ID as inherent identification information, and the node ID is a hash value (e.g. bit length of 160 bits) obtained by hashing, for example, IP addresses or manufacturing numbers by a common hash function (e.g. SHA-1), whereby nodes are distributed and located in one ID space without deviation.

Accordingly, the node ID obtained (hashed) by a common hash function has a very low possibility of having the same value if the IP address or the manufacturing number differs. Here, because the hash function is well known, detailed explanation is omitted.

Further, nodes nn respectively retain DHT. This DHT regulates a transfer destination of various types of messages on the overlay network 9. Specifically, a routing table (transfer destination table) is included, and in the routing table, a plurality of groups of a node ID, IP address and port number thereof of nodes nn that are appropriately apart in the node ID space are registered.

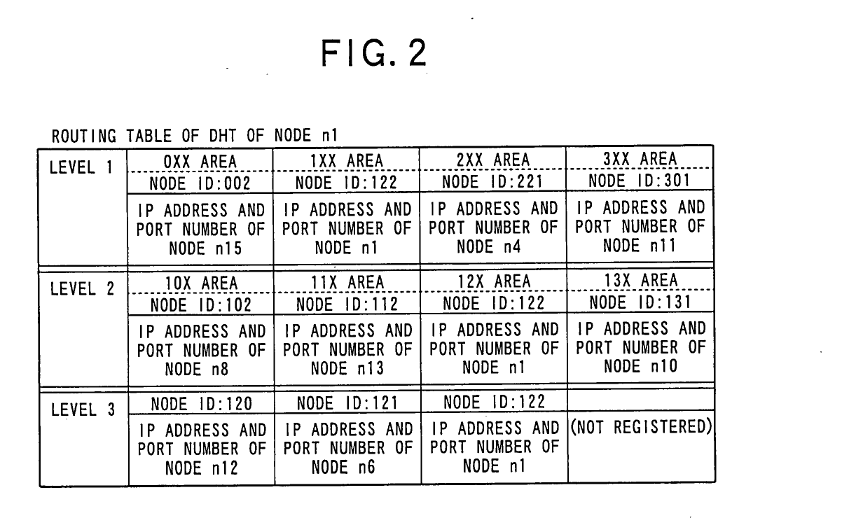

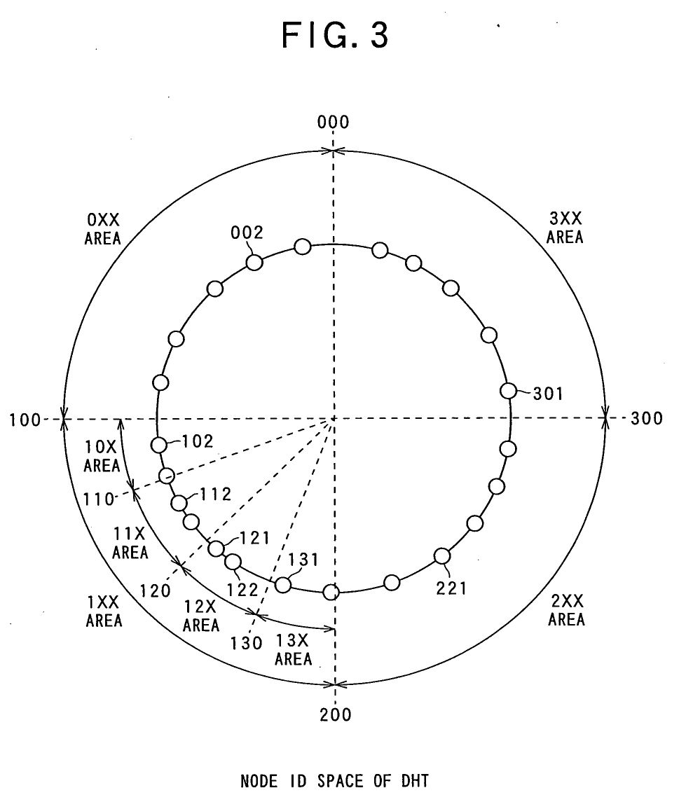

FIG. 2 is a view showing an example of a routing table of DHT retained by the node n1. FIG. 3 is a conceptual view showing an example of a node ID space.

Here, in the examples of FIGS. 2 and 3, for easy of explanation, bit length of a node ID is set up to be 2 bits×3 digits=6 bits, and each digit is expressed by quaternary number (an integer between 0 and 3) (practically, a longer bit length is used and each digit is divided into, for example, 4 bits each and expressed by hexadecimal of 0 to f).

In the example of FIG. 2, the routing table of the DHT consists of tables of levels 1 to 3 (classified into a plurality of levels). In a table entry of each level, a node ID and an IP address and port number of a node nn corresponding to the node ID are associated and registered with respective of each area. Each area of a table in each level is an area obtained by dividing the node ID space of the DHT. For example, as shown in FIG. 3, in level 1, an entire node ID space of the DHT is divided into four parts and an area where node IDs “000” to “033” exist is designated as a 0XX area, an area where node IDs “100” to “133” exist is designated as a 1XX area, an area where node IDs “200” to “233” exist is designated as a 2XX area, and an area where node IDs “300” to “333” exist is designated as a 3XX area. Further, in level 2, areas in level 1 (in other words, areas “0XX” to “3XX”) are further divided into four parts. For example, a 1XX area is divided into four parts and an area where node IDs “100” to “103” exist is designated as a 10X area, an area where node IDs “110” to “113” exist is designated as a 11X area, an area where node IDs “120” to “123” exist is designated as a 12X area, and an area where node IDs “130” to “133” exist is designated as a 13X area.

Then, for example, provided that a node ID of a node n1 is “122”, as shown in FIG. 2, an own node ID, an IP address and the like (because IP address belongs to the own, registration of the IP address in the routing table is not required) are registered in a table of 1XX area (an area where the own node exists) in level 1 of the node n1. In areas where the own node does not exist (i.e. areas of 0XX, 2XX, and 3XX), node IDs, IP addresses and the like of other arbitrary nodes nn are respectively registered.

Further, as shown in FIG. 2, own node ID, IP address and the like (because IP address belongs to the own, registration of the IP address in the routing table is not required) are registered in the table of 12X area (an area where the own node exists) in level 2 of the node n1. In areas where the own node does not exist (i.e. areas of 10X, 11X, and 13X), node IDs, IP addresses and the like of other arbitrary nodes nn are respectively registered.

Further, in level 3 of such the node n1, node IDs that are between “120” and “122”, IP address and the like (because IP address belongs to the own, registration of the IP address in the routing table is not required) are registered, as shown in FIG. 2.

In the examples of FIGS. 2 and 3, since a bit length of node ID is set up to be 3 digits×2 bits, a table having three levels, level one to three, can completely cover. However, when a bit length of node ID is increased, more tables are required as many when the length increases (for example, in a case where the bit length of node ID is set up to be 16 digits×4 bits, a table sufficient for 16 levels is required).

Accordingly, in a routing table of DHT according to the present embodiment, the higher the level becomes the narrower the area becomes.

For example, such the DHT is given when a non-participant node participates in the overlay network 9.

According to this embodiment, all programs broadcasted from respective broadcast stations 2a to 2c are assigned to the respective nodes nn so as to be in charge of recording, and the respective nodes nn store (record) the assigned programs of record in charge so as to share the programs among a plurality of nodes nn. In the embodiment, two examples will be described: an example that respective nodes nn determine time of own record in charge and an example that when respective nodes nn participate and register in the system S, the programs of record in charge are assigned from the registration server 2d and memorized inside the device as a table of programs of record in charge. Table 1 shows the latter example, in other word, the programs of record in charge assigned to a given node nn from the registration server 2d. The respective nodes nn receive and record (store) the recording channel at the recording (storing) start time.

TABLE 1

| RECORDING | RECORDING | RECORDING |
|---|---|---|
| START TIME | END TIME | CHANNEL |
| 2006.08.03 00:00:00 | 2006.08.03 00:30:00 | 1 |
| 2006.08.03 06:00:00 | 2006.08.03 06:30:00 | 1 |
| 2006.08.03 12:00:00 | 2006.08.03 12:30:00 | 1 |
| 2006.08.03 18:00:00 | 2006.08.03 19:00:00 | 1 |
| 2006.08.03 20:00:00 | 2006.08.03 21:00:00 | 2 |
| 2006.08.03 22:30:00 | 2006.08.03 23:00:00 | 1 |
| 2006.08.04 00:30:00 | 2006.08.04 01:00:00 | 1 |
| 2006.08.04 05:30:00 | 2006.08.04 06:00:00 | 1 |
| 2006.08.04 10:00:00 | 2006.08.04 11:00:00 | 3 |
| . | . | . |
| . | . | . |
| . | . | . |

In a case of the latter example, it is preferable for the registration server 2d to assign the program of record in charge in accordance with regional information received from the respective node devices nn. For example, in a case where the regional information indicates Nagoya, the registration server 2d assigns a broadcast channel of a broadcast station that is receivable in Nagoya region as a recording channel.

Further, a content ID inherent in a program (an example of identification information) is respectively generated in these content data and stored in respective nodes nn in correspondence with content data. The content ID is generated in response to, for example, “date of broadcasting program” and “broadcast channel” (i.e. recording start time and recording channel).

For example, with respect to the program broadcasted on broadcast channel 1 at 18:00:00, Aug. 4, 2006, the number string “2006080418000001” is hashed by a hash function shared to obtain the above-mentioned node ID, and a content ID uniquely corresponding to the program is generated (i.e. content ID is arranged in the same ID space as the node ID).

Accordingly, possibility that the content ID obtained (hashed) by the common hash function has the same value is extremely low when the broadcast channel and broadcast time zone are different. Therefore, even in a case where the program has the same title (e.g. program weekly broadcasted), the content ID is different when the time and date or the broadcast channel is different. Here in a case where the above-mentioned number string has the same digit number as the node ID, it is possible to use the number string as is, as a content ID.

Further, index information indicative of location of the content data thus distributed and stored (index list including node information (IP addresses, port number and the like) of respective content retention nodes storing the content data) is managed by a node nn (hereinafter referred to as a “root node”), a manager of the above-mentioned content ID. For example, index information regarding a content data of program X is managed by a node n13 being a root node of the content (content ID), and index information regarding a content data of program Y is managed by a node n14 being a root node of the content (content ID). In other words, because root nodes are divided by content, load can be distributed. Moreover, even in a case where same content data (same content ID) are stored in a plurality of content retention nodes, index information of such the content data can be managed by one root node. Further, such a root node is determined to be a node nn having a node ID closest to, for example, content ID (e.g. upper digits match more).

Then, the node nn (content retention node) that stores the content data sends a publish message (a message indicative of a request for registering node information of a storing source to a node nn participating in the overlay network 9 because the content data are stored, and a message to publish the information through the root node) as a registration message including the content ID of the content data and own node information (node information such as IP address and port number indicative of the content retention node storing content data) to the root node based on the content ID in order to notify that the content data are stored. Thus, the publish message reaches the root node by DHT routing using content ID as a key.

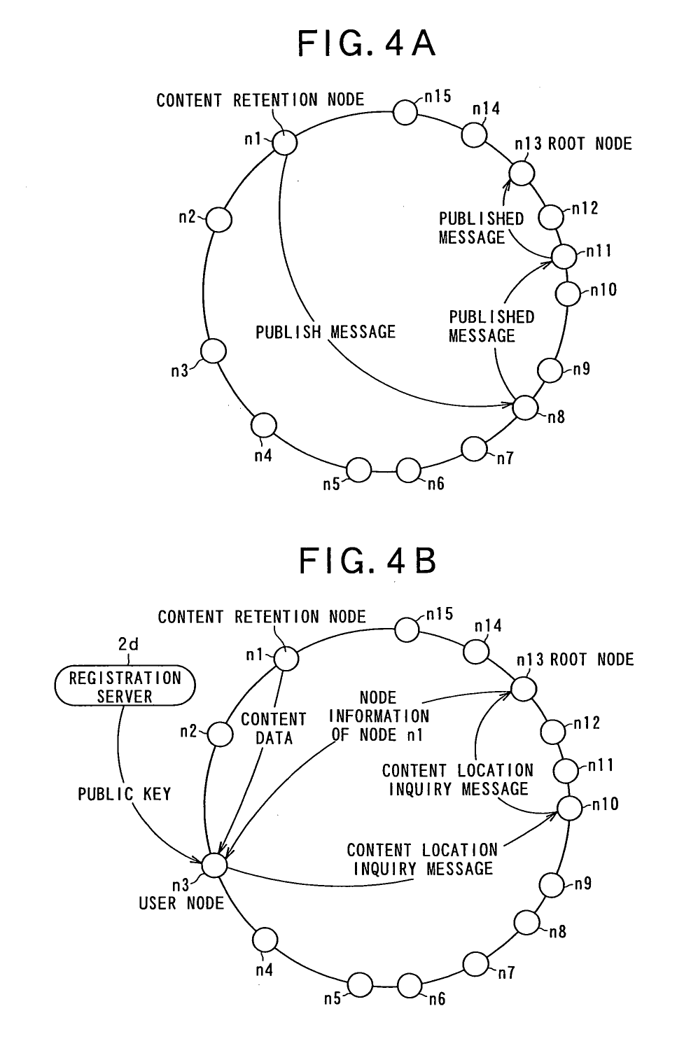

FIG. 4A is a schematic view showing an example of a flow of a publish message sent from the content retention node in a node ID space of DHT.

In the example of FIG. 4A, for example, a node n1 being a content retention node refers to a table of level 1 of the own DHT, acquires an IP address and a port number of, for example, a node n8 having node ID closest to a content ID included in the publish message (e.g. upper digits match more), and sends the publish message to the IP address and the port number.

Meanwhile, the node n8 receives the publish message, refers to a table of level 2 of the own DHT, acquires an IP address and a port number of, for example, a node n11 having node ID closest to content ID included in the publish message (e.g. upper digits match more), and transfers the publish message to the IP address and the port number.

On the contrary, a node n11 receives the publish message, refers to a table of level 3 of the own DHT, acquires an IP address and a port number of, for example, a node n13 having node ID closest to content ID included in the publish message (e.g. upper digits match more), and transfers the publish message to the IP address and the port number.

On the contrary thereto, the node n13 receives the publish message, refers to a table of level 4 of the own DHT, and recognizes that a node having node ID closest to the content ID included in the publish message (e.g. upper digits match more) is the node itself. In other words, the node n13 recognizes that itself is a root node of the content ID. Then the node n13 registers the node information included in the publish message in the own index information.

Here, the node information included in the publish message is also registered (cached) in a node nn (node n8 and node nil in the example of FIG. 4A) on a transfer route from the content retention node to the root node.

In a case where a user of a node nn desires to view a program broadcasted in past years, the node nn (hereinafter referred to as “user node”) desiring to acquire content data of the program hashes by a common hash function, “time and date of broadcasting the program” and “broadcast channel” (i.e. recording start time and recording channel) of the program designated by the user to generate a content ID. The node nn sends a content location inquiry (search) message including the content ID and the node information of the own (the user node) to other nodes nn according to the routing table of the own DHT. Thus, in a manner similar to the publish message, the content location inquiry message finally reaches the root node of the content ID by DHT routing using content ID as a key, through several nodes nn (hereinafter referred to as “relay node”). Further, the root node sends a content sending request message including node information of the user node to any one of the content retention nodes where the node information is registered in the index information. Accordingly, the user node acquires (downloads) the content data related to the content location inquiry (search) message from the content retention node.

FIG. 4B is a schematic view showing an example of a flow of a content location inquiry message sent from the user node, in a node ID space of DHT.

In the example of FIG. 4B, for example, a node n3 being a user node refers to the own table, acquires an IP address and a port number of, for example, a node n10 having node ID closest to a content ID included in the content location inquiry message (e.g. upper digits match more), and sends the content location inquiry message to the IP address and the port number.

Meanwhile, the node n10 receives the content location inquiry message, refers to the own table, acquires an IP address and a port number of, for example, the node n13 having node ID closest to content ID included in the content location inquiry message (e.g. upper digits match more), and transfers the content location inquiry message to the IP address and the port number.

On the contrary thereto, the node n13 receives the content location inquiry message, refers to the own table, and recognizes that a node having node ID closest to the content ID included in the content location inquiry message (e.g. upper digits match more) is the own node. In other words, the node n13 recognizes that itself is a root node of the content ID. The node n13 sends the node information (IP address and the port number) of the node n1 being the content retention node registered in the own index information, to the node n3 being the user node.

Accordingly, the node n13 being the user node requests the content data related to the content location inquiry message to the node n1 being the content retention node and acquires (downloads). Because the acquired content data are encoded by an encode key inherent in the node n1, a public key of the node n1 is acquired from the registration server 2d in order to decode the content data. The content data are decoded using the public key and viewed. Specifically, the node n3 sends the node information of the node n1 to the registration server 2d to request the public key, and the registration server 2d receiving the node information sends the public key of the node n1 corresponding to the node information of thus sent node n1, to the node n3.

Here, as shown in FIG. 4B, the configuration is not limited to the configuration (Push) where the user node requests to the content retention node to send, and acquires the content data. It may be, for example, the configuration (Pull) where the root node sends a content send request message including the node information and the content ID of the user node to the node n1 being the content retention node, and the node n1 being the content retention node receives the content send request message, acquires from the content data stored by the own the content data corresponding to the content ID included in the content send request message, and sends the content data to the node n3 based on the node information (IP address and port number) of the node n3 being the user node included in the content send request message. The user node may also acquire (receive) the node information from a cash node cashing the same node information as the root node before the content location inquiry message reaches the root node.

Then the user node is connected to a log server 2e to record a view log of thus acquired content data, and then an accounting process is carried out in a settlement server 2f for a secondary use of thus acquired content data.

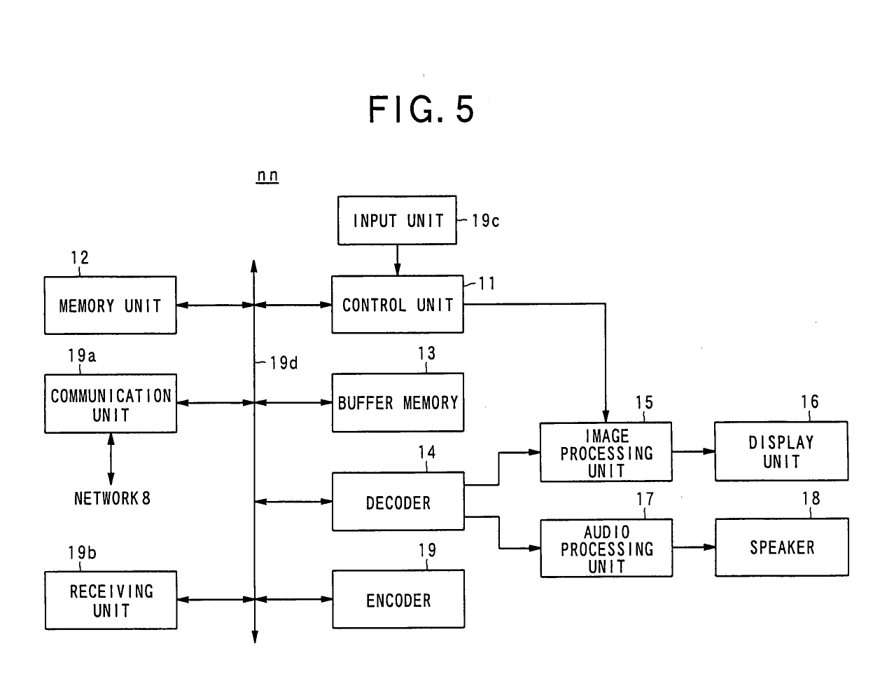

Next, with reference to FIG. 5, structure and function of a node nn are described.

FIG. 5 is a view showing an example of a schematic configuration of the node nn.

The node nn is configured as shown in FIG. 5 by including: a control unit 11 being a computer made up of a CPU having computing function, a RAM for work, and a ROM for memorizing various data and programs; a memory unit 12, as a program information storage means and an encode key memory means, which are configured by an HDD or the like for memorizing and storing various data (e.g. content data, node information, DHT, and IP address of the registration server 2d, the log server 2e, the settlement server 2f and the library server 2g), secret key inherent in the node nn (an example of encode key), record-in-charge information indicative of program to be recorded by the own (Refer to Table 1) or the like; a buffer memory 13 for temporarily storing received content data; a decoder 14 as a decoding means for decoding (data stretch or decryption) encoded video data (image information) and audio data (voice information) included in content data; an image processing unit 15 for providing a predetermined graphic process to the video data thus decoded or the like and outputting the data as video signal; a display unit 16 such as CRT and liquid crystal display for displaying image based on the video signal outputted from the image processing unit 15, or the like; an audio processing unit 17 for converting the decoded audio data in use of digital/analog (D/A) conversion into an analog audio signal, amplifying the converted signal by an amplifier and outputting the same; a speaker 18 for outputting the audio signal outputted from the audio processing unit 17 as acoustic wave; an encoder 19 as an encoding means for encoding the received content data; a communication unit 19a for carrying out communication control with other node nn and respective servers 2d to 2g through the network 8; a receiving unit 19b such as a tuner for receiving content data of the program broadcasted from a broadcast station 2a, an input unit 19c (e.g. a keyboard, a mouse, or an operation panel) for receiving instruction from a user and providing an instruction signal in response to the instruction to the control unit 11, wherein the control unit 11, the memory unit 12, the buffer memory 13, the decoder 14, the encoder 19, the communication unit 19a, and the receiving unit 19b are mutually connected through a bus 19d. Here, a personal computer, a set top box (STB), or a TV receiver is applicable as the nodes nn.

In such the configuration, when CPU reads out and executes a program (including a processing program of the present invention) memorized in the memory unit 12 or the like, the control unit 11 integrally controls and carries out a process as any one of the above-mentioned user node, relay node, root node, cache node, content retention node and the like. The control unit 11 functions as a program information receiving means, a program information storage means, a public message sending means, a program information sending means, an encode key memory means, an encoding means, a participation registration means, a record-in-charge information acquisition means, a decode key sending means, a search message sending means, a node information acquisition means, a program information request means, a program information acquisition means, a decode key request information sending means, a decode key acquisition means, and a decoding means according to the present invention and carries out various processes described later.

Further, according to the embodiment, because the content data are encoded and memorized and stored, a secret key inherent in respective nodes nn is memorized and stored, for example, when the node nn is manufactured or shipped, for example, in a secure nonvolatile memory as an encode key memory means provided in the memory unit 12. Such the secret key is protected from rewriting, deleting, and taking out from outside.

Here, the processing program may be downloaded, for example, from the predetermined server in the network 8. For example, it may be recorded in the recording medium such as CD-ROM and read through a driver of the recording medium.

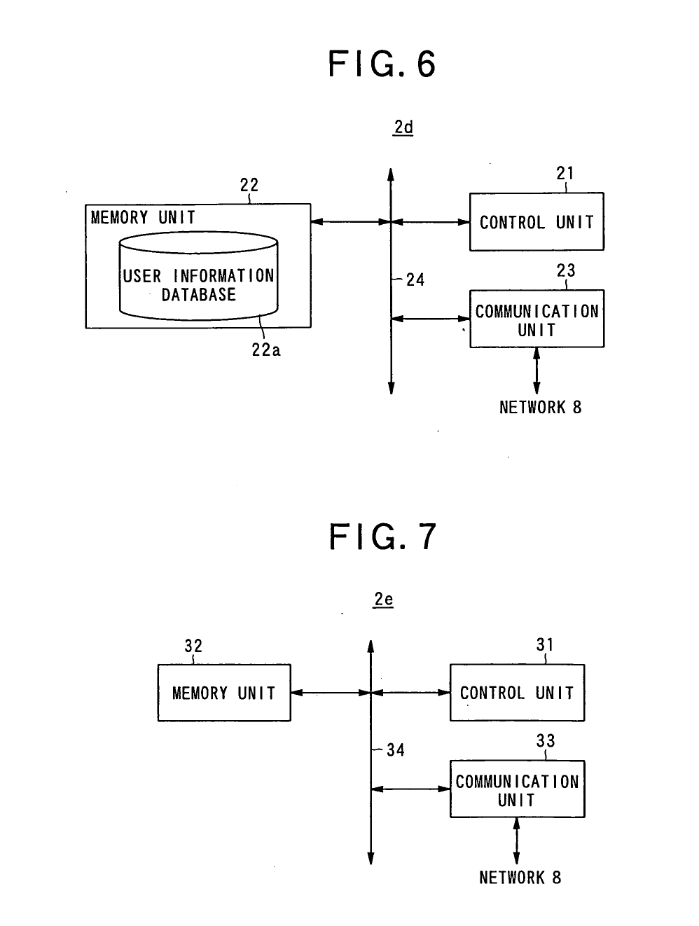

Next, with reference to FIGS. 6 to 9, configurations and functions of the registration server 2d, a log server 2e, a settlement server 2f and a library server 2g are described. The embodiment is an example of the case where the registration server 2d and the settlement server 2f function as a server device according to the present invention.

First, with reference to FIG. 6, a configuration and a function of the registration server 2d are described.

FIG. 6 is a view showing an example of a schematic configuration of the registration server 2d.

An ordinary server computer is applicable to the registration server 2d and the registration server 2d is configured as shown in FIG. 6 by including: a control unit 21 including a CPU, a RAM for work, and a ROM for memorizing various data and programs; a memory unit 22 including HDD for memorizing (storing) various data (e.g. IP address of a log server 2e, a settlement server 2f, and a library server 2g) and programs; and a communication unit 23 for carrying out communication control with the node nn through a network 8, wherein respective components are mutually connected through a bus 24.

In such the configuration, when CPU reads out and executes a program memorized by the memory unit 22 or the like, the control unit 21 integrally controls and functions as a record-in-charge information decision means and a record-in-charge information sending means, a user information management means, and a decode key memory means and a decode key sending means, of a server device of the present invention, and carries out various processes described later.

The registration server 2d configures the user information database 22a in the memory unit 22. In the memory unit 22, the followings are registered (memorized) as a user information in correspondence with a node ID of respective nodes nn (Refer to Table 2):

(1) individual information of the user of the respective nodes nn (e.g. user ID, address, name, e-mail address);
(2) regional information including postal number and telephone number of an area where respective nodes nn are installed;
(3) settlement information including accounting information, settlement method, credit card number;
(4) public key (an example of decode key) for decoding content data encoded (scrambled) by a secret key inherent in respective nodes nn; and
(5) past record of sending public key to respective nodes nn.

TABLE 2

| | | | | | PUBLIC KEY SENDING | |
|---|---|---|---|---|---|---|
| | | | | | RECORD | |
| NODE | INDIVIDUAL | REGIONAL | SETTLEMENT | PUBLIC | CONTENT | |
| ID | INFORMATION | INFORMATION | INFORMATION | KEY | ID | FREQUENCY |
| 002 | INDIVIDUAL | REGIONAL | SETTLEMENT | PUBLIC | 112 | 1 |
| | INFORMATION | INFORMATION | INFORMATION | KEY | 005 | 2 |
| | (002) | (002) | (002) | (002) | 301 | 1 |
| 003 | INDIVIDUAL | REGIONAL | SETTLEMENT | PUBLIC | 322 | 1 |
| | INFORMATION | INFORMATION | INFORMATION | KEY | 132 | 1 |
| | (003) | (003) | (003) | (003) | | |
| 103 | INDIVIDUAL | REGIONAL | SETTLEMENT | PUBLIC | 001 | 3 |
| | INFORMATION | INFORMATION | INFORMATION | KEY | 121 | 4 |
| | (103) | (103) | (103) | (103) | | |
| 120 | INDIVIDUAL | REGIONAL | SETTLEMENT | PUBLIC | 201 | 1 |
| | INFORMATION | INFORMATION | INFORMATION | KEY | 213 | 4 |
| | (120) | (120) | (120) | (120) | 100 | 2 |
| . | . | . | . | . | . | . |
| . | . | . | . | . | . | . |
| . | . | . | . | . | . | . |

The node IDs of respective nodes nn are generated and registered based on, for example, a manufacturing number at the time of manufacturing or shipping the nodes nn. User individual information, regional information, settlement information, and the public key are registered in correspondence with the node ID when the user purchases the node nn. Or these node IDs and individual information are registered when the user completes application procedures for a content delivery system S after purchasing the node nn (when participating in the overlay network 9). Then settlement information is sent from the registration server 2d to the settlement server 2f, and an accounting process is carried out in the settlement server 2f to the users of respective nodes nn. Besides, the user information database 22a is also accessible from other respective servers 2c to 2g, and the user individual information of the user information database 22a and the settlement information are available.

Here, the server processing program, for example, may be downloaded from the predetermined server in the network 8, or for example may be recorded in a recording medium such as CD-ROM and read through a driver of the recording medium.

Next, with reference to FIG. 7, a configuration and a function of the log server 2e are described.

FIG. 7 is a view showing an example of a schematic configuration of the log server 2e.

Ordinary server computers are applicable to the log server 2e, and the log server 2e is configured as shown in FIG. 7 by including: a control unit 31 including a CPU, a RAM for work, and a ROM for memorizing various data and programs; a memory unit 32 including HDD for memorizing (storing) various data (e.g. IP address of a registration server 2d, a log server 2e, and a library server 2g) and programs; and a communication unit 33 for carrying out communication control with nodes nn and respective servers through a network 8, wherein respective components are mutually connected through a bus 34.

In the memory unit 32, after respective programs are broadcasted from respective broadcast stations 2a to 2c, system use records are managed by using the system S with respect to who views, what program is viewed, how many times the program is viewed (downloaded), and the like. Specifically to:

(i) the use record every user of respective nodes nn is managed (memorized) in correspondence with the node ID inherent in respective nodes nn (Refer to Table 3), and
(ii) the use record every program (content) is managed (memorized) in correspondence with content ID inherent in respective programs (Refer to Table 4).

TABLE 3

USE RECORD (i)

| | | FREQUENCY OF |
|---|---|---|
| | | VIEWING (FREQUENCY OF |
| NODE ID | CONTENT ID | DOWNLOADING) |
| 002 | 112 | 4 |
| | 005 | 2 |
| | 301 | 1 |
| 003 | 322 | 3 |
| | 132 | 1 |
| 103 | 001 | 3 |
| | 221 | 4 |
| 120 | 201 | 3 |
| | 213 | 4 |
| | 100 | 2 |
| . | . | . |
| . | . | . |
| . | . | . |

TABLE 4
USE RECORD (ii)

| | FREQUENCY OF BEING VIEWED |
|---|---|
| CONTENT ID | (FREQUENCY OF BEING DOWNLOADED) |
| 112 | 146 |
| 005 | 244 |
| 301 | 17 |
| 322 | 89 |
| 132 | 288 |
| 001 | 488 |
| 221 | 1090 |
| 201 | 136 |
| 213 | 235 |
| 100 | 512 |
| . | . |
| . | . |
| . | . |

Then, the system use records of the respective nodes nn (i) are periodically sent to the settlement server 2f, and the settlement server 2f carries out an accounting process in response to the system use records. Further, the use records of the respective programs (ii) are sent in response to a request from the registration server 2d. In the registration server 2d receiving this, record-in-charge programs to be recorded by a new node nn are assigned based on use records of respective programs (i.e. in consideration of a viewing rate of respective programs) and record-in-charge programs to be recorded by respective nodes nn are reassigned.

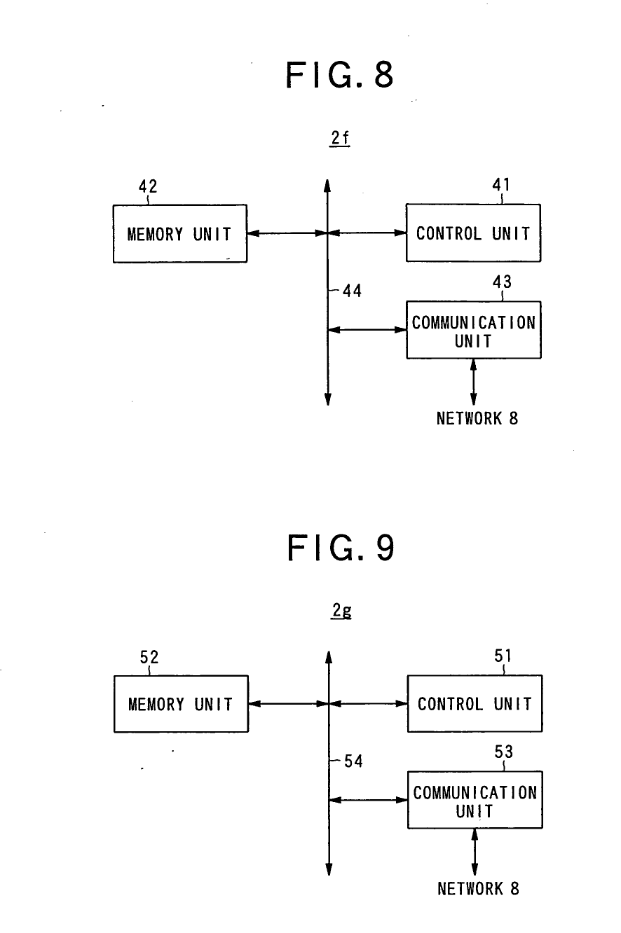

Next, with reference to FIG. 8, a configuration and a function of the settlement server 2f are described.

FIG. 8 is a view showing an example of a schematic configuration of the settlement server 2f.

An ordinary server computer is applicable as the settlement server 2f, and the settlement server 2f is configured as shown in FIG. 8 by including: a control unit 41 including a CPU, a RAM for work, and a ROM for memorizing various data and programs; a memory unit 42 including HDD for memorizing (storing) various data (e.g. IP address of a registration server 2d, a log server 2e, and a library server 2g) and programs; and a communication unit 43 for carrying out communication control with nodes nn and respective servers through a network 8, wherein respective components are mutually connected through a bus 44.

In such the configuration, when CPU reads out and executes the program memorized by the memory unit 42 or the like, the control unit 41 integrally controls and functions as an accounting process means of a server device of the present invention. The control unit 41 carries out an accounting process to charge the user of respective nodes nn for use fee in response to the use record received from the log server 2e by every user of the respective nodes nn. When the accounting process is actually carried out, the user information database 22a of the registration server 2d is accessed to utilize the user individual information and the settlement information.

Next, with reference to FIG. 9, a configuration and a function of the library server 2g are described.

FIG. 9 is a view showing an example of a schematic configuration of the library server 2g.

An ordinary server computer is applicable to the library server 2g, and the library server 2g is configured as shown in FIG. 9 by including: a control unit 51 including a CPU, a RAM for work, and a ROM for memorizing various data and programs; a memory unit 52 including HDD for memorizing (storing) various data (e.g. IP address of a registration server 2d, a log server 2e, and a settlement server 2f) and programs; and a communication unit 53 for carrying out communication control with nodes nn and respective servers through a network 8, wherein respective components are mutually connected through a bus 54.

In such the configuration, when CPU reads out and executes the program memorized by the memory unit 52 or the like, the control unit 51 integrally controls and causes the memory unit 52 to memorize the program broadcasted in the past from the respective broadcast stations 2a to 2c.

Specifically, when the record-in-charge program is to be recorded in the respective nodes nn, in a case where the program (e.g. relatively old program) already recorded should be deleted in order to record a new program because the memory capacity of the program memory region in the node exceeds, the program (content data) to be deleted from the respective nodes nn is received (uploaded) and memorized (managed) in the memory unit 52.

According to such the configuration of the content delivery system S, it is possible to record and store all programs broadcasted in the past from the respective broadcast stations 2a to 2c, in any one of respective nodes nn being in charge of record and the library server 52g. Therefore, it is possible to respond to delivery requests of the respective nodes nn with respect to all programs broadcasted.

### [2. Operation of Content Delivery System]

Next, an operation of the content delivery system S is described.

[2-1. Process of Node nn]

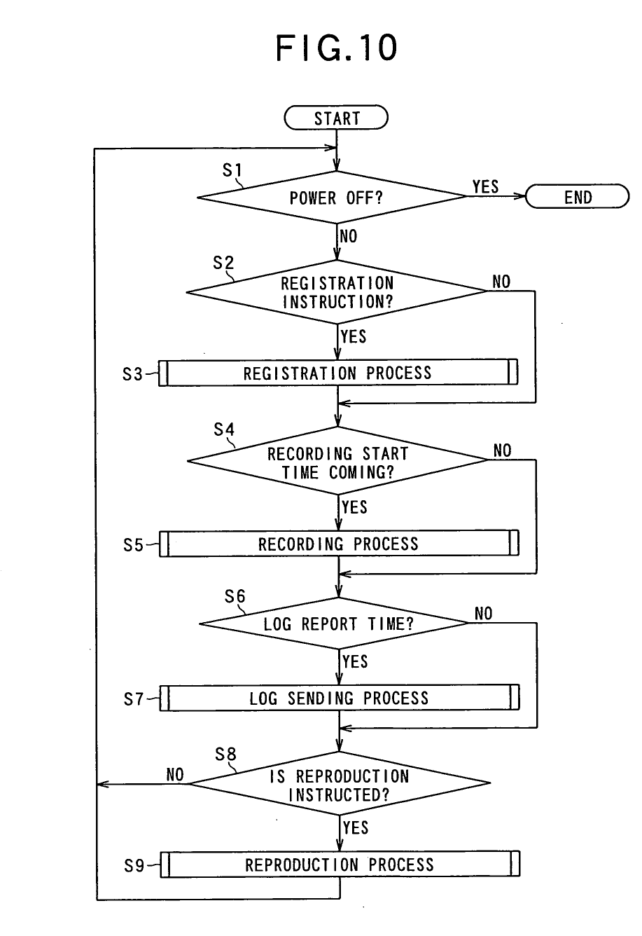

FIG. 10 is a flowchart showing a process in the control unit 11 of the node nn. When the node nn is powered on, the processing program of the present invention is executed under the control of the control unit 11.

First, it is judged whether or not the power is off (Step S1). In a case where the power is not off (Step S: No), the process goes to Step S2 onward.

By the user operating the input unit 19c or the like, the control unit 11 judges whether or not participation and registration in the content delivery system S are instructed (Step S2). In a case where the participation and registration in the content delivery system S are instructed (Step S2: Yes), the control unit 11 carries out “registration process” (Step S3).

On the other hand, in a case where the participation and registration in the content delivery system S are not instructed (Step S2: No), the control unit 11 goes to Step S4 and judges in reference to the record-in-charge program table (Table 1) memorized in the memory unit 12 whether or not it is recording start time of the program of record in charge (Step S4). In a case where it is the recording start time of the program of record in charge (Step S4: Yes), the control unit 11 carries out “recording process” (Step S5).

On the other hand, in a case where it is not the recording start time of the program of record in charge (Step S4: No), the control unit 11 goes to Step S6 and judges whether or not it is time to send the content viewing log to the log server 2e (log report time) (Step S6).

Then, in a case where it is the log report time (Step S6: Yes), the control unit 11 carries out “log sending process” (Step S7). In a case where it is not the log report time (Step S6: No), the control unit 11 goes to Step S8.

Next, by the user operating the input unit 19c or the like, the control unit 11 judges whether or not reproduction is instructed with respect to the program broadcasted in the past from the broadcast stations 2a to 2c (Step S8). In a case where the reproduction is instructed (Step S8: Yes), the control unit 11 carries out “reproduction process” to search the program within the content delivery system S (Step S9).

On the other hand, in a case where the reproduction is not instructed (Step S8: No), the control unit 11 returns to Step S1 and repeats the processes of the above-mentioned Steps S1 to S9 until the power is off (Step S1: Yes).

Registration Process in Step S3

Next, “registration process” in the above-mentioned Step S3 is described. Here, two cases of the “registration process” are described, one a case where the record-in-charge program is determined in the respective nodes nn and memorized as a record-in-charge program table, and the other a case where record-in-charge program is assigned from the registration server 2d at the time of participation and registration in the system S of respective nodes nn and memorized as a record-in-charge program table (refer to Table 1) inside the device.

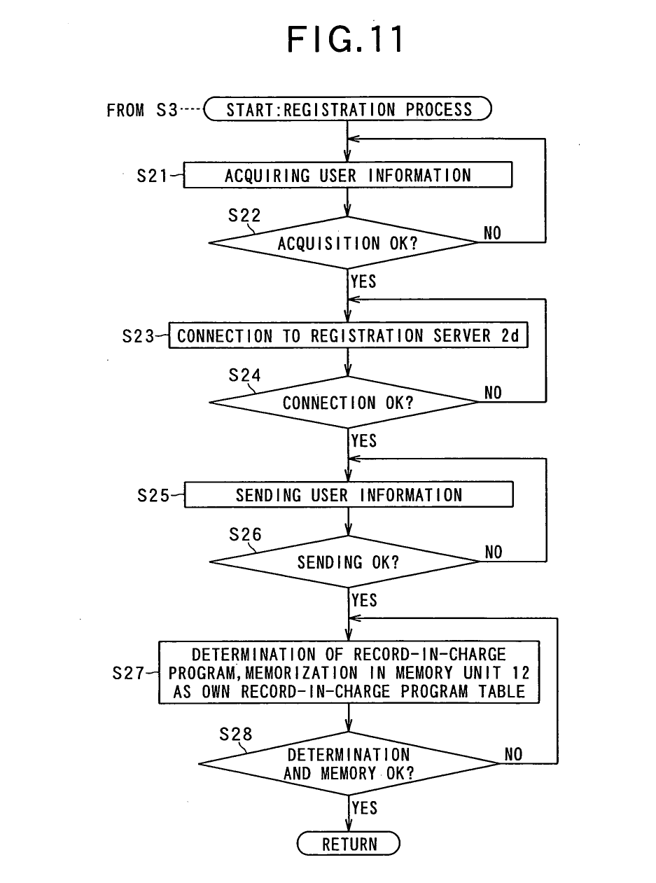

First, the registration process in case of determining the record-in-charge program in the respective nodes nn is described using a flowchart in FIG. 11.

First, the control unit 11 acquires user information including individual information, regional information, and settlement information of the user of the node nn (Step S21). Specifically, the control unit 11 urges the user to input the above-mentioned user information, and the user operates the input unit 19c, thereby acquiring the user information.

Then, the control unit 11 judges whether or not the user information is acquired (Step S22). In a case where the user information can be acquired (Step S22: Yes), the control unit 11 connects (accesses) to the registration server 2d (Step S23). In a case where the user information can not be acquired (Step S22: No), the control unit 11 goes to Step S21. The user information acquisition processes including urging input of user information are repeated until the user information can be acquired.

Next, it is judged whether or not the control unit 11 can connect to the registration server 2d (Step S24). In a case where it can connect to the registration server 2d (Step S24: Yes), the control unit 11 functions as a participation registration means and sends the user information acquired in Step S21 to the registration server 2d (Step S25). On the other hand, in a case where it cannot connect to the registration server 2d (Step S24: No), the control unit 11 goes to Step S23. Connection to the registration server 2d is repeated until it can connect to the registration server 2d.

Then, the control unit 11 judges whether or not the user information can be sent to the registration server 2d (Step S26). In a case where the user information can be sent (Step S26: Yes), the control unit 11 determines a record-in-charge program and memorizes it as an own record-in-charge program table in the memory unit 12 (Step S27). As a determination method of the record-in-charge program, for example, a remainder is calculated by dividing the manufacturing number inherent to the node nn by the number of the broadcast channel number receivable for the own, and the channel number corresponding to the number of the obtained remainder is determined as a recording channel. A remainder is calculated by dividing the manufacturing number by total number of slots, and a time corresponding to the obtained reminder is determined as recording time. With respect to the total number of slots, for example, in a case of recording as content data of every 30 minutes for 24 hours of one day from 0:00, 48 slots (recording timing) are generated. In a case where the remainder obtained by dividing the own manufacturing number by 48 is 3, the third slot, or 30 minutes from 1:00 a.m. to 1:30 a.m. is the recording time. In other configuration, record-in-charge programs may be sorted into a plurality of nodes nn by manufacturing time and manufacturing place when the nodes are manufactured, and assigned and memorized, so that the plurality of nodes nn can cover programs of all broadcast channels. Further, a plurality of pieces of record-in-charge information may be previously memorized in the memory unit 12 by every region receivable of respective broadcast channels, the node nn itself may extract the record-in-charge information of the region corresponding to the regional information of the node nn from a plurality of pieces of the record-in-charge information based on the regional information included in the user information acquired in Step S21, and it may be rememorized as the own record-in-charge program table.

On the other hand, in a case where the user information cannot be sent (Step S26: No), the sending process in Step S25 is repeated until it can be sent.

In Step S28, in a case where the control unit 11 judges whether or not the record-in-charge information can be determined and memorized (Step S28) and the record-in-charge information can be determined and memorized (Step S28: Yes), “registration process” is completed. In a case where the record-in-charge information cannot be determined/memorized (Step S28: No), the control unit 11 monitors and repeats record-in-charge determination/memorization process until acquisition.

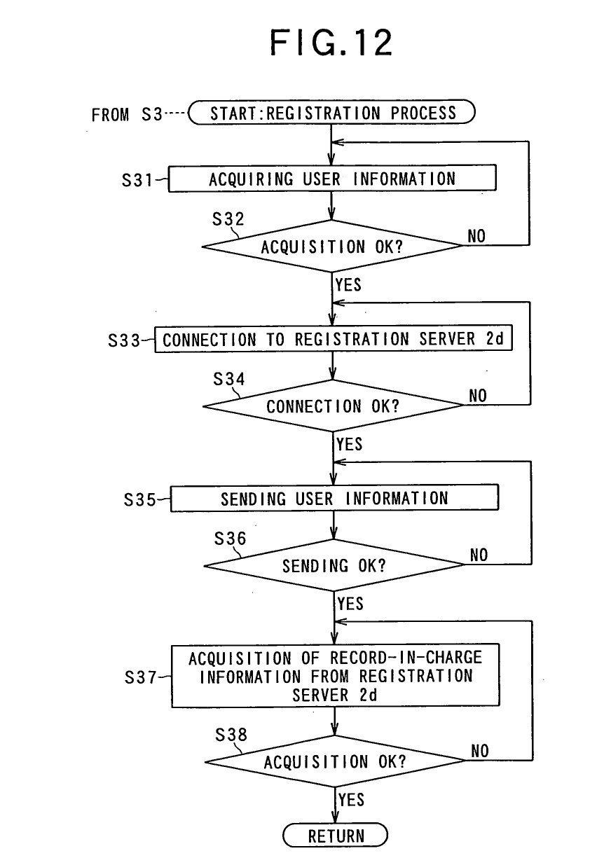

Next, the registration process where the record-in-charge programs are assigned from the registration server 2d is described using a flowchart in FIG. 12. Because the processes from Steps S31 to S36 are respectively similar to the processes from Steps S21 to S26, description is omitted.

In Step S37, the control unit 11 functions as a record-in-charge information acquisition means and acquires the record-in-charge information from the registration server 2d (Step S37). Although it is specifically described in detail in the process of registration server 2d, in the registration server 2d, the regional record-in-charge information corresponding to the regional information of the node nn is determined and sent to the node nn based on the regional information included in the user information sent in Step S35.

In Step S38, it is judged whether or not the record-in-charge information can be acquired (Step S38). In a case where the record-in-charge information can be acquired (Step S38: Yes), “registration process” is completed. In a case where the record-in-charge information cannot be acquired (Step S38: No), the control unit 11 waits for the record information sent from the registration server 2d until acquisition.

Recording Process in Step S5

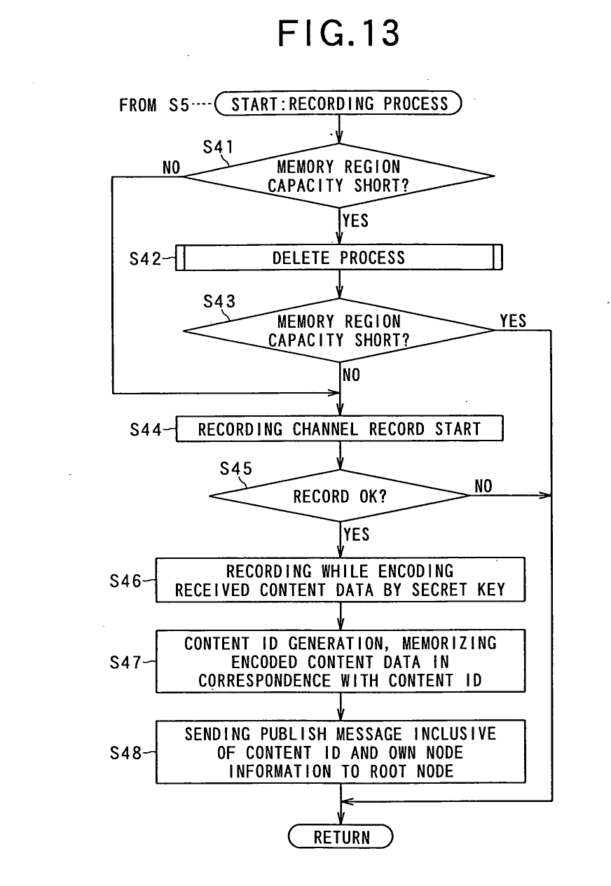

Next, “recording process” in the above-mentioned Step S5 is described using a flowchart in FIG. 13.

First, the control unit 11 judges whether or not capacity of the memory region of the memory unit 12 for recording a program is short (Step S41). Specifically, it is judged whether or not a left memory region is more than a predetermined threshold. The threshold is, for example, a capacity for the next recording time (e.g. 30 minutes).

Based on a result of judgment, in a case of short capacity of the memory region (Step S41: Yes), the control unit 11 carries out “delete process” (Step S42), and judges again whether or not the capacity is short (Step S43). “Delete process” is described later in detail. In a case where the capacity is still short even after “delete process” is carried out (Step S43: Yes), the process is completed. In a case where a plurality of nodes nn are previously assigned to a given program for recording in charge, other nodes nn in charge of record can cover enough by recording the subject program even though a single node nn is unable to record because of capacity shortage.

On the other hand, in a case where the capacity of the memory region is not short (Step S41: No, S43: No), the control unit 11 functions as a program information receiving means and a program information storage means, receives broadcast on recording channel to be recorded to receive content data (program), and starts recording (Step S44).

Then, the control unit 11 judges whether or not the recording is appropriately carried out (Step S45). In a case where recording is appropriately carried out (Step S45: Yes), the control unit 11 functions as a encoding means, and controls in such manner that the received content data are encoded by the encoder 19 by using a secret key (an example of encode key) that is inherent to the own and memorized in the memory unit 12 (in other words, the content data received by using the secret key being encoded), and are recorded (stored) in the memory unit 12 at the same time (Step S46).

Then, upon completion of the recording process, the control unit 11 generates an inherent content ID in response to “time and date of the program broadcasted” and “broadcast channel” (i.e. recording start time and recording channel), and memorizes it in the memory unit 12 in correspondence with thus encoded content data (Step S47).

Next, the control unit 11 functions as a public message sending means, sends a publish message including the above-mentioned content ID and the own node information to a root node (Step S48), and finishes the process. Then thus sent publish message reaches the root node of the above-mentioned content ID through several relay nodes as explained with reference to FIG. 4A. Upon receipt of the publish message, the root node memorizes the node information included in the message, or registers it in index information. Accordingly, the node nn sending the above-mentioned publish message becomes a content retention node.

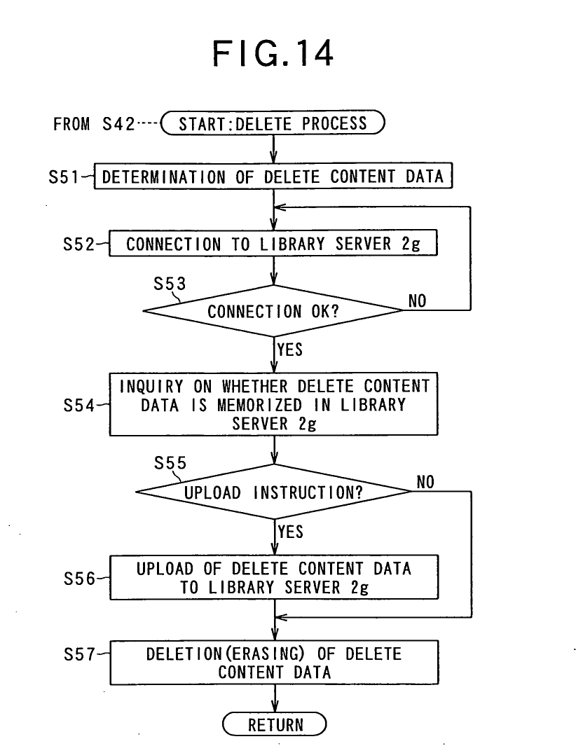

Next, “delete process” in the above-mentioned Step S5 is described using a flowchart of FIG. 14.

First, the control unit 11 determines delete content data among content data memorized in the memory unit 12 (Step S51). In a method of selecting the delete content data, for example, the subject content data selected among content data memorized in the memory unit 12 may be: the oldest data in the broadcast time and date (recording time and date), the data that already passes over the lifetime which respective content data are provided with (e.g. lifetime information may be added with the program when the program is broadcasted from respective broadcast stations 2a to 2c), the data that have the fewest content delivery requests, or the data that have the lowest viewing rate (the viewing rate may be inquired at the log server 2e managing use records (Refer to Table 4) of respective programs). Further, it is preferable to select the delete content data of short capacity in the above-mentioned Step S43.

Then the control unit 11 is connected (accesses) to the library server 2g (Step S52), and next judges whether or not it can connect to the library server 2g (Step S53). In a case where it cannot be connected to the library server 2g (Step S53: Yes), the control unit 11 inquiries the library server 2g about whether or not the delete content data thus determined in Step S51 are memorized in the library server 2g (Step S54). In a case where the delete content data are not memorized in the library server 2g, the library server 2g instructs to send (upload) the delete content data. On the other hand, in a case where it cannot be connected to the library server 2g (Step S55: No), the control unit 11 goes to Step S52 and tries to connect to the library server 2g until connection to the library server 2g is established.

Then, the control unit 11 judges whether or not the instruction to upload (send) delete content data is made from the library server 2g (Step S55). In a case where the instruction is not made to upload delete content data (Step S55: No), the control unit 11 goes to Step S57. In a case where the instruction is made to upload delete content data (Step S55: Yes), the control unit 11 uploads (sends) the delete content data to the library server 2g (Step S56). Here, according to the present embodiment, when sending the delete content data to the library server 2g, the control unit 11 decodes the content by the own public key and then sends it to the library server 2g.

Subsequently, the delete content data are deleted from the memory unit 12 in Step S57 (Step S57). Then the delete message (a message to request the root node or the like to delete registration of the node information because the content data are deleted) is sent to its root node based on the content ID of the delete content data. Therefore, the delete message reaches the root node by DHT routing using a content ID as a key in a manner similar to the publish message when it is published. In the root node and the respective nodes nn in the transfer route of the delete message, the node information of the node nn (i.e. the node nn storing delete content data) being a delete message sending source that is cashed by the own index information is deleted. Thus, “delete process” of FIG. 14 is completed.

Log Sending Process in Step S7

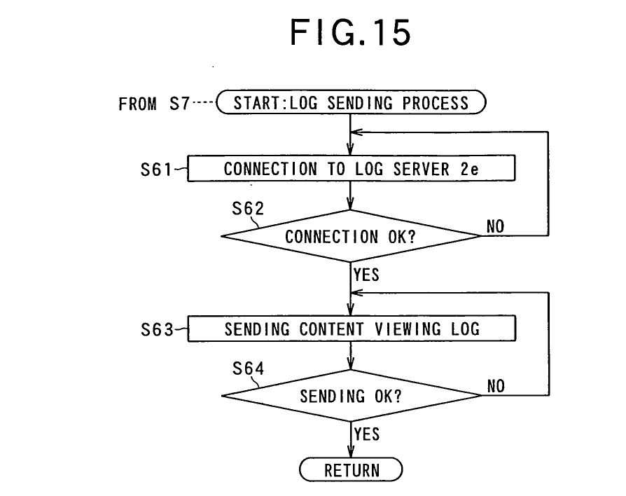

Next, “log sending process” in the above-mentioned Step S7 is described using a flowchart of FIG. 15.

First, the control unit 11 connects (accesses) to the log server 2e (Step S61), and next judges whether or not it can connect to the log server 2e (Step S62). In a case where it cannot be connected to the log server 2e (Step S62: No), the control unit 11 goes to Step S61, and tries to connect to the log server 2e until it can be connected to the log server 2e.

On the other hand, in a case where it can be connected to the log server 2e (Step S62: Yes), the control unit 11 sends the content viewing log to the log server 2e (Step S63), and judges whether or not it can send (Step S64). In a case where it can send the content viewing log to the log server 2e (Step S64: Yes), the process is completed. In a case where it cannot send (Step S64: No), the control unit 11 goes to Step S63, and tries sending to the log server 2e until it can send.

Reproduction Process in Step S9

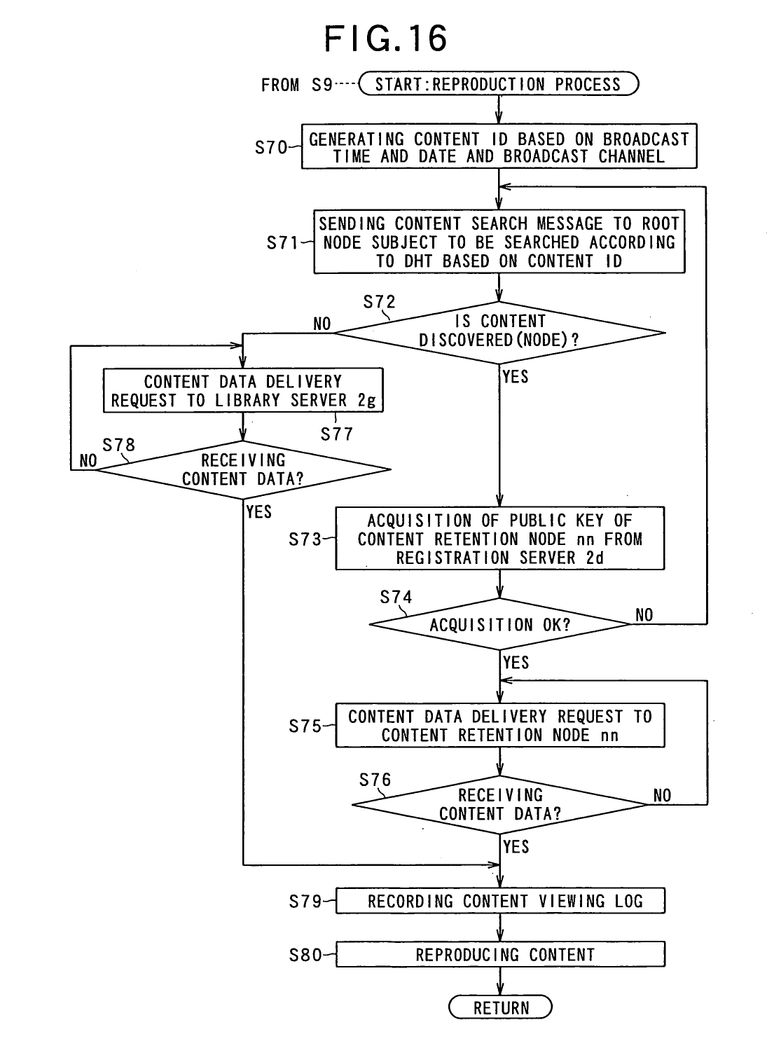

Next, “reproduction process” in the above-mentioned Step S9 is described using a flowchart of FIG. 16. In this process, the user operates the input unit 19c or the like to input a broadcast time and date and a broadcast channel of a program subject to a reproduction instruction, and the process starts by the reproduction instruction, with respect to the program broadcasted from the broadcast stations 2a to 2c in the past.

First, the control unit 11 generates the content ID based on the broadcast time and date and the broadcast channel of the program instructed to input (Step S70), and carries out a content search process. Specifically, the control unit 11 functions as a search message sending means, sends the content location inquiry (search) message including the generated content ID and the node information of the own (the user node) to the root node and waits for a response (Step S71).

For example, in a case where a single program is recorded in a single node nn as a single content datum, a single content ID is generated based on a broadcast time and date and a broadcast channel of the program instructed to input, and a single content location inquiry message is sent based on the DHT routing based on the content ID. In a case where a single program (24-hour program) is recorded in a single node nn as a single content datum for the first one hour and recorded in another node as a single content datum for latter one hour, the content ID is generated based on the broadcast time and date (recording start time for the first one hour) and the broadcast channel with respect to the first one hour content data, the content ID is generated based on the broadcast time and date (recording start time for the latter one hour) and the broadcast channel with respect to the latter one hour content data, and two content location inquiry messages are sent. Thus, a plurality of content data necessary to be searched and acquired in some cases even though a single program is instructed to reproduce.

Then, the content location inquiry (search) message sent reaches the root node of the content ID through several relay nodes as described with reference to FIG. 4B.

Then, when the root node receives the content location inquiry (search) message, it judges whether or not node information of a content retention node storing content data corresponding to the content ID is registered in index information. In a case where it is registered, the root node sends to the user node the node information of the registered content retention node nn (any single or a plurality of content retention nodes in the case of a plurality of content retention nodes), as a response message.

On the other hand, in a case where the node information of the content retention node nn storing the content data corresponding to the content ID is not registered in the index information, the root node sends a response message indicating that it is not registered, to the user node.

Meanwhile, when the user node receives the above-mentioned response message, the control unit 11 refers to the response message and judges whether or not the content data can be found (Step S72). In other words, it is judged whether or not the response message can be received to all content location inquiry messages sent in Step S71. In a case where it can be received, it is judged whether or not the node information of the content retention node nn retaining the content data related to the program to be instructed to reproduce can be acquired from the root node (node information acquisition means). Based on a result of judgment, in a case where all content data can be found (Step S72: Yes), the control unit 11 functions as a decode key request information sending means and a decode key acquisition means, sends to the registration server 2d the decode key request information including the node ID included in the node information of the respective content retention nodes nn advised from the root node, and acquires the public key of the respective content retention nodes nn from the registration server 2d (Step S73). When node information of a plurality of content retention nodes is advised from a single root node, the control unit 11 acquires public keys for all content retention nodes, and may request all content retention nodes to deliver content data or request any one of content retention nodes to deliver content data. Here, the content ID of contents subject to be requested to deliver is also sent to the registration server 2d. This is because the public key sending record (Refer to Table 2) is recorded in the registration server 2d.

Then, it is judged whether or not the public key is acquired (Step S74). In a case where the public key cannot be acquired (Step S74: No), the control unit 11 goes to Step 71 and sends the content location inquiry (search) message again. Meanwhile, because a given program is recorded in a plurality of nodes nn due to record by viewing and duplicated record-in-charge assignment and the effect is published, location of a plurality of nodes nn is advised (cached). Accordingly, it is configured not to return the node information of the same content retention node, when for example the same content location inquiry (search) message is received. Therefore, it is possible to acquire the node information of the other content retention node different from the content retention node that cannot acquire the public key in Step S74, with respect to resending of the content location inquiry (search) message.

In a case where the public key was acquired in the past, the process of Step S74 is unnecessary. For example, to explain by comparison between a public key sending record related to the user information of Table 2 and a use record of Table 3, the public key sending record of Table 2 shows that the node nn having the node ID “002” has the registration server 2d send the public key once in order to decode the content having content ID “112”, and the use record of Table 3 shows that the node having node ID “002” uses the content having content ID “112” four times. This means, for example, that the node having node ID “002” has an experience of searching and acquiring the content having content ID “112”, and only the public key of the node nn (content retention node) being the content data storing source is still memorized though the content data themselves are deleted from the memory unit 12 every time. Therefore, only the content data are acquired several times (four times in an example of Table 3).

On the other hand, in a case where the public key can be acquired (Step S74: Yes), the control unit 11 functions as a program information request means, and requests the respective content retention nodes nn to deliver the content data (Step S75). In a case where it is judged whether or not the content data is received (Step S76) and the content data cannot be received (Step S76: No), the process goes to Step S75 and the control unit 11 requests to deliver the content data until it receives the content data.

In Step S72, in a case where the content data cannot be found (Step S72: No), in other words, in a case where there is a content location inquiry messages that cannot acquire any node information of the content retention node nn among respective content location inquiry messages thus sent in Step S71, the library server 2g is requested to deliver the content data related to the content location inquiry message (Step S77). For example, in a case where two content location inquiry messages related to two content data are sent in Step S71, the node information of content retention node nn related to one content data is obtained from the root node, and the node information of the content retention node nn related to the other content data cannot be obtained from the root node, only content data related to the other content data are requested to the library server 2g. To decrease load of the library server 2g, those obtaining the node information of the content retention node nn should request the content retention node nn to deliver and to obtain from the other node nn as much as possible. Such the configuration is preferable.

Then, it is judged whether or not the content data are received from the library server 2g (Step S78). In a case where the content data cannot be received (Step S78: No), the process goes to Step S77, and the control unit 11 requests the library server 2g to deliver the content data until it receives the content data.

Consequently, the control unit 11 functions as a program information acquisition means. When receiving (acquiring) the content data in Steps S76 and S78 (Step S76: Yes, S78: Yes), the control unit 11 memorizes thus received (acquired) content data in the memory unit 12 and records the content viewing log (Step S79). The content viewing log is periodically sent to the log server 2e (Refer to Steps S6, S7) and records the content viewing frequency, viewing time and date or the like in correspondence with the content ID every time receiving the content data.

Then, the control unit 11 reproduces the content data (Step S80) and completes the process. Here, because the content data thus received (acquired) from the content retention node nn (Step S76) are acquired in an encoded state, the control unit 11 functions as an encoding means, and the content data are reproduced while being decoded in the decoder 14 by using the public key of the content retention node acquired from the registration server 2d in Step S73. Here, in a case where the starting location of the program subject to be instructed to reproduce by the user is located in the mid of the single content datum, a single content ID is generated based on time and date where the broadcast time and date of the program instructed to reproduce is standardized to the content recording start time (e.g. in this example, 18:00 on Aug. 3, 2006 in a case of desiring to view the program broadcasted from 18:05, Aug. 3, 2006) and broadcast channel. Then a single content location inquiry message based on DHT routing based on the content ID is sent to the root node. Then, finally, the content data including the above-mentioned program is received (acquired) from the content retention node nn. In this case, a process of skipping up to the starting location of the program thus instructed to reproduce is carried out and then the program is reproduced (i.e. reproduced from the mid of the acquired content data).

Further, in a case where the ending location of the program instructed to reproduce by the user as well is a location in the mid of a single content datum, the content data including the above-mentioned program is received (acquired) from the content retention node nn. Here, it is reproduced up to the ending location of the program instructed to reproduce (i.e. reproduced up to the mid of the acquired content data).

Here, thus reproduced content data are encoded using the own secret key memorized in the memory unit 12 after the reproduction and stored in the memory unit 12. Therefore, the node nn functions as a content retention node of thus reproduced content data. In other words, the publish message including the content ID and the own node information is sent to the root node and published. Therefore, because the content data of the more popular program are recorded by the more users and the content data are stored in the more nodes nn, the more popular programs become accessible (easy to acquire) without loading a burden on specific devices such as the server device. Even the program failed in record can be acquired without fail.

### [2-2. Process of Registration Server 2d]

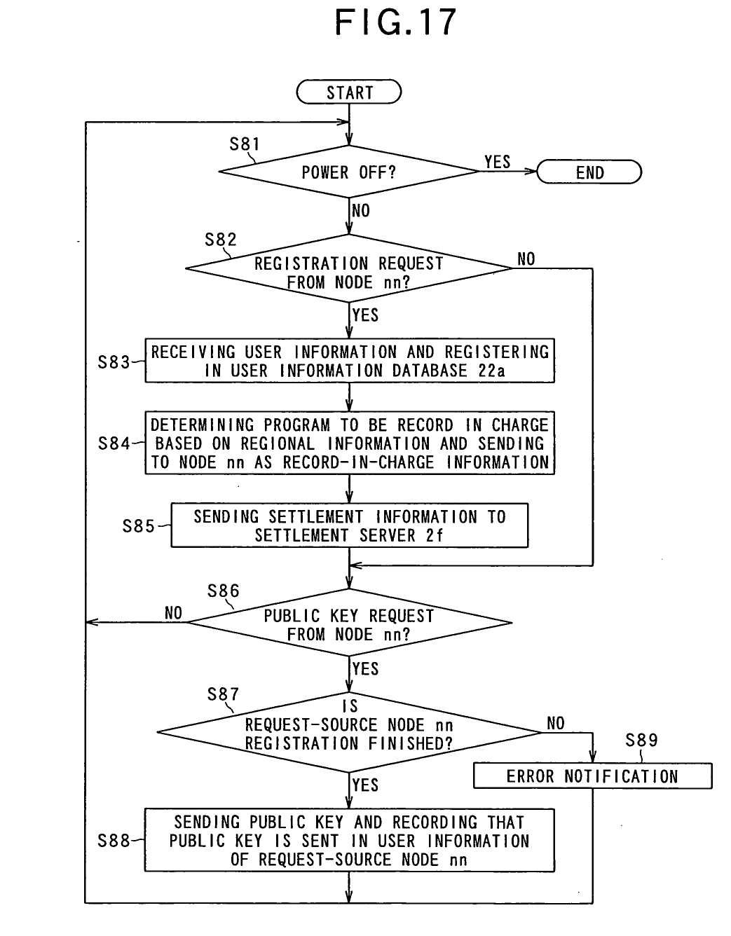

FIG. 17 is a flowchart showing a process in the control unit 21 of the registration server 2d. There will be described a case where the registration server 2d allocates a record-in-charge program to the respective nodes nn. When the registration server 2d is powered on, a server processing program of the present invention is executed under the control of the control unit 21 as shown in FIG. 17.

First, it is judged whether or not the power is off (Step S81). In a case where the power is not off (Step S81: No), the process goes to Step S82 onward.

Then, the control unit 21 judges whether or not the control unit 21 receives a registration request from a new node nn nonparticipating in the content delivery system S (Step S82). In a case where the control unit 21 does not receive the registration request (Step S82: No), it goes to Step S86. In a case where it receives the registration request (Step S82: Yes), the control unit 21 receives user information from the node nn and registers it in the user information database 22a (Step S83).

Subsequently, the control unit 21 functions as a record-in-charge information decision means and a record-in-charge information sending means, determines a program subject to the node nn in charge of record, and sends to the node nn as the record-in-charge information (Step S84). Here, it is preferable to determine the record-in-charge information based on the regional information included in received user information. In other words, in a case where the regional information indicates Nagoya, a broadcast channel of a broadcast station receivable in Nagoya region is assigned as a recording channel. In a case where the regional information indicates Tokyo, a broadcast channel of a broadcast station receivable in Tokyo region is assigned as a recording channel. It is preferable to assign record in charge in such manner that all programs broadcasted from all broadcast stations are definitely recorded by any node nn participating in the content delivery system S. Here, in a case where the record-in-charge program is determined by the respective nodes nn, the process in Step S84 is not carried out.

Next, the settlement information included in the user information received in Step S83 is sent to the settlement server 2f (Step S85). Here, after sending the settlement information to the settlement server 2f, the settlement information may be deleted from the user information database 22a. Subsequently, the settlement server 2f carries out an accounting process of charging use fee of predetermined amount to the user of the node nn based on the settlement information. Then, for example, the use fee is drawn from user's bank account and thus charged use fee is paid to a program producer, a writer of broadcast station side or the like in response to a predetermined standards. Here the accounting process carried out here is one carried out at the time of registration in the content delivery system S. The accounting process carried out to respective users based on a use record of the content is carried out later based on the use record sent from the log server 2e described later.

Subsequently, it is judged whether or not the public key is requested from the node nn (Step S86). Based on the result of judgment, in a case where the public key is not requested (Step S86: No), the process goes to Step S81. In a case where the public key is requested (Step S86: Yes), it is judged whether or not the request source node nn is a registered node nn that is officially registered in the content delivery system S (Step S87). Specifically, it is judged based on whether or not the node ID of the request source node nn is received and the node ID is registered in the user information database 22a. Here, it may be configured that not only the node ID but also arbitrary information of the user information in correspondence with the node ID (e.g. telephone number) is urged to input and send in the request source node nn, the information thus sent is checked against the information registered in the user information database 22a to judge whether or not it is already registered.

Then, in a case of the registered node nn (Step S87: Yes), the control unit 21 functions as a decode key sending means. The control unit 21 acquires a public key in correspondence with the node ID of the requested content retention node, from the user information database 22a, sends it to the request source node nn, and records that it sends the public key to the user information of the request source node nn, in correspondence with the node ID of the request source node nn (Step S88). Then, the process goes to Step S81. Here, the control unit 21 records the public key sending record in correspondence with the content ID of the content that the request source node nn desires to acquire (reproduce). To explain more specifically with reference to Table 2, for example in a case where the node nn having the node ID “103” desires to acquire (reproduce) the content having the contend ID “121” and requests the public key having the node ID “120” being the content retention node storing the content data having the content ID “121”, the registration server 2d acquires the public key (120) having the node ID “120” from the user information database 22a, sends it to the node nn having the node ID “103”, and adds one time to the content ID “101” of the public key sending record of the node ID “103” in correspondence with node ID “103” to update.

On the other hand, in a case where it is not a registered node nn (Step S87: No), an error message stating that the public key cannot be sent because it is not an official registrant (Step S89). The process goes to Step S81.

Then, the above-mentioned processes in Steps S81 to S89 are repeated until the power is off (Step S81: Yes).

Further, the processes described above are repeated while the power is on. In addition to this, the registration server 2d is configured to periodically receive the use record (Refer to Table 4) of the respective programs from the log server 2e (i.e. in consideration of a viewing rate of respective programs), assign a record-in-charge program to be recorded by the new node nn, and reassign a record-in-charge program to be recorded by respective nodes nn. In a case where the record-in-charge program is reassigned, the registration server 2d is configured to send new record-in-charge information to respective nodes nn and instruct to rewrite with old (current) record-in-charge information, and the node nn receiving this memorizes the new record-in-charge information in the memory unit 12 in stead of the old (current) record-in-charge information.

### [2-3. Process of Log Server 2e]

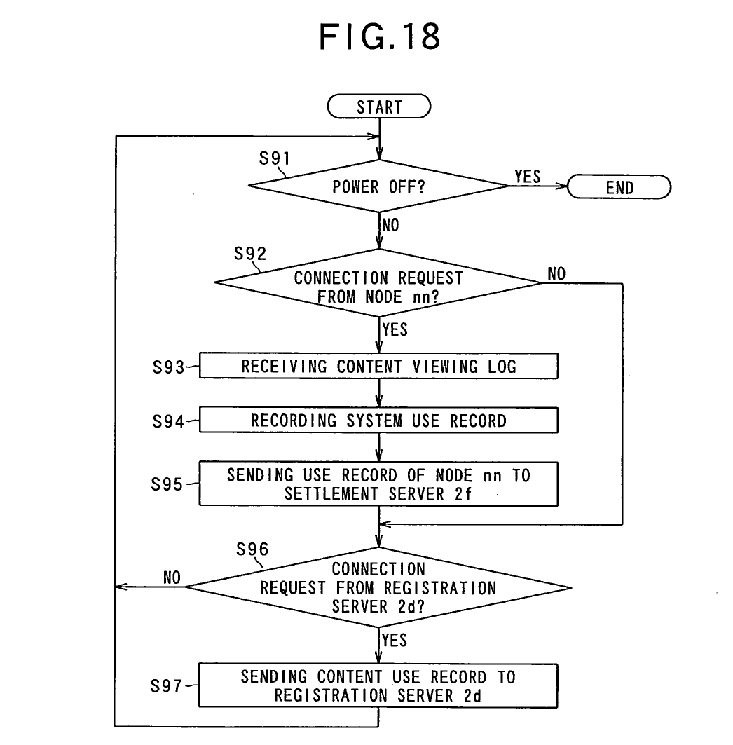

FIG. 18 is a flowchart showing a process in the control unit 31 of the log server 2e. In the process shown in FIG. 18, the server processing program of the present invention is executed under the control of the control unit 31 when the log server 2e is powered on.

First, it is judged whether or not the power is off (Step S91). In a case where the power is not off (Step S91: No), the process goes to Step S92 onward.

Then, the control unit 31 judges whether or not it receives connection request from a node nn (Step S92). In a case where the control unit 31 does not receive the connection request (Step S92: No), it goes to Step S96. In a case where it receives the connection request (Step S92: Yes), the control unit 31 receives a content viewing log from the node nn and records the system use record (Refer to Table 3 and Table 4). Then the control unit 31 sends (reports) a use record of the node nn (Refer to Table 3) to the settlement server 2f (Step S96). Then the settlement server 2f carries out the accounting process of charging the predetermined amount of use fee to the user of the node nn based on the use record. Then, for example, the use fee is drawn from user's bank account and thus charged use fee is paid to a program producer, a writer of broadcast side or the like in response to a predetermined standards.

Subsequently, the control unit 31 judges whether or not it receives connection request from the registration server 2d (Step S96). In a case where it does not receive the connection request (Step S96: No), the process goes to Step S91. In a case where it receives the connection request (Step S96: Yes), the use record of the content (Refer to Table 4) is sent to the registration server 2d (Step S97), and the process goes to Step S91.

Then the above-mentioned processes in Steps S91 to S97 are repeated until the power is off (Step S91: Yes).

### [2-4. Process of Library Server 2g]

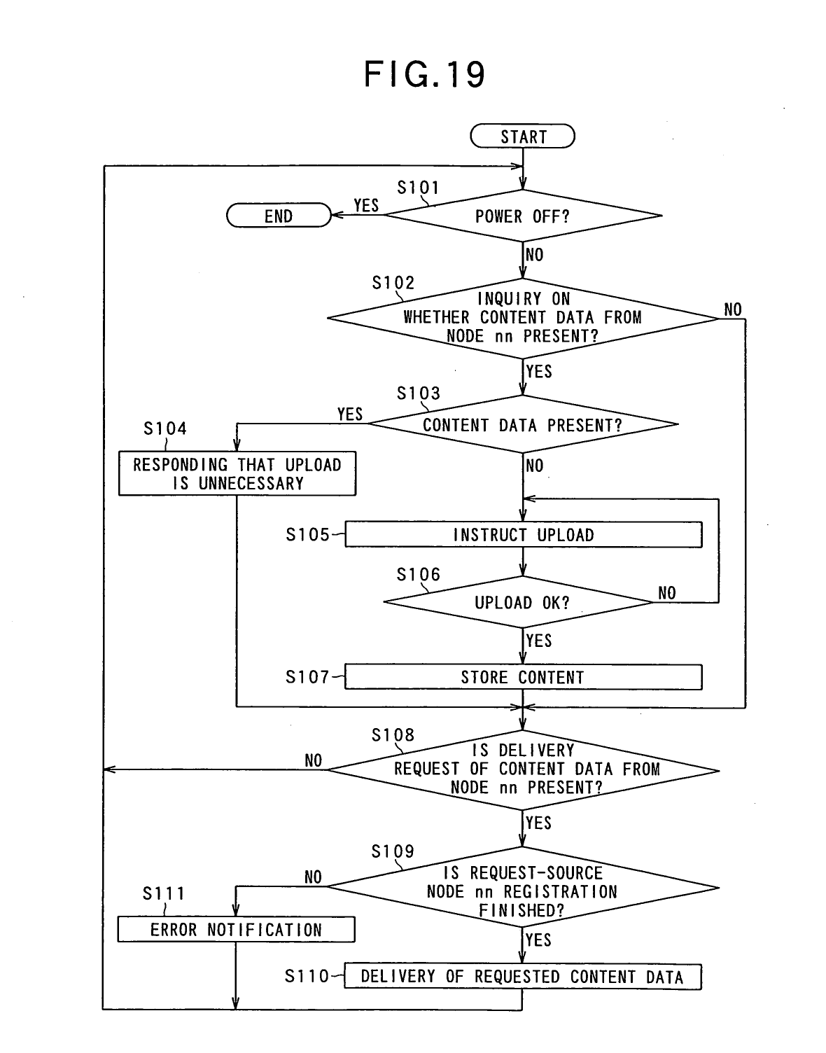

FIG. 19 is a flowchart showing a process in the control unit 51 of the library server 2g. When the library server 2g is powered on, a server processing program of the present invention is executed under the control of the control unit 51 as shown in FIG. 19.

First, it is judged whether or not the power is off (Step S101). In a case where the power is not off (Step S101: No), the process goes to Step S102 onward.

Then, the control unit 51 receives the content ID from the node nn and judges whether or not presence of the content data is inquired (Step S102). This inquiry is the process corresponding to the process of delete process (Steps S5, S54) in the above-mentioned node nn.

As the result of judgment, in a case where the presence of the content data is not inquired (Step S102: No), the process goes to Step S108. In a case where the presence of the content data is inquired (Step S102: Yes), it is judged whether or not the inquired content data are memorized (Step S103). In a case where they are memorized, it is replied that content related to the content ID is not required to be uploaded (sent) (Step S104), and the process goes to Step S108. On the other hand, in a case where the content data inquired are not memorized (Step S103: No), the content related to the content ID is instructed to be uploaded (sent) (Step S105).

Then, it is judged whether or not the upload of the content is carried out without fail (Step S106). In a case where the upload (sending) is not carried out without fail (Step S106: No), the process goes to Step S105. The control unit 51 continues to watch and instruct until the content upload (sending) is completed. In a case where the content is uploaded without fail (Step S106: Yes), the control unit 51 stores thus uploaded content data in the memory unit 52 in correspondence with the content ID (Step S107). Here, the present embodiment is on the premise that the content stored in the library server 2g is the content data that is not encoded. Accordingly, the library server 2g receives the content data decoded by the public key of the node nn (i.e. the public key of the content retention node), from the respective nodes nn. Besides, for example, it may be configured in such manner that the content data encoded are received from the respective nodes nn, decoded the public key of the node nn that is acquired from the registration server 2d, and stored in the memory unit 52.

Subsequently, it is judged whether or not the content data is requested to deliver from the node nn (Step S108). In a case where the delivery is not requested (Step S108: No), the process goes to Step S101. In a case where the delivery is requested (Step S108: Yes), it is judged whether or not the request source node nn is the already registered node nn that is officially registered in the content delivery system S (Step S109). Specifically, the node ID of the request source node nn is sent to the registration server 2d and it is inquired to the registration server 2d and judged whether or not the node ID is registered in the user information database 22a.

Then, in a case where it is the already registered node nn (Step S109: Yes), the requested content data are delivered to the request source node nn (Step S110), and the process goes to Step S101. On the other hand, in a case where it is not the already registered node nn (Step S109: No), the error message stating that the content data cannot be sent because it is not an official registrant is sent (Step S111), and the process goes to Step S101.

Then the processes from Steps S101 to S111 are repeated until the power is off (Step S101: Yes).

Thus, according to the present embodiment, a plurality of nodes nn receiving the program broadcasted from the respective broadcast stations 2a to 2c are stored in a manner sharable with other node nn in correspondence with the content ID inherent to the program respectively assigned as record in charge. Therefore, it is possible for the user of the respective nodes nn to acquire the programs broadcasted in the past from the node nn recording and storing the program and view it without loading burden on the specific server or the like.

Further, when the respective nodes nn record and store the program, the public message with the content ID inherent to the program as a key is sent to the root node and published. Further, when the request of the program recorded and stored is received from the other node nn, the requested program is sent to the other node nn. Therefore, the node (user node) desiring a given program generates the content ID of the desired program, and sends the content location inquiry (search) message to the other node nn by the content ID as a key. Accordingly, it is possible to know a location of the content data of the desired program (node information of the content retention node storing this) through the root node.

Further, when the content data are encoded and stored, and requested, the respective nodes nn send thus encoded content data to the request source node nn. Therefore, it is possible to improve the security. Further, the public key (one example of decode key) to decode the encoded content data is stored and managed by the registration server 2d. Therefore, since the public key of the node nn (content retention node) storing the encoded content data is acquired from the registration server 2d when the encoded content data are acquired, it is possible to decode the encoded content data and view them. Besides, the public key for decoding the encoded content data is a key inherent to the respective nodes nn and stored and managed by the only registration server 2d knowing the public key for all the nodes nn. The other node nn cannot generate the public key for decoding the content data encoded and stored in a given node nn. Therefore, unless the public key is acquired by designating the node nn to the registration server 2d, it is impossible to decode the data encoded in the node nn. Thus it is possible to further secure the security.

Further, the registration server 2d determines the record-in-charge information indicative of the program to be recorded by respective nodes nn, and it is possible to assign the programs broadcasted from the respective broadcast stations 2a to 2c, to the respective nodes nn as record in charge without deviation in order to instruct the respective nodes nn.

Further, the registration server 2d determines the record-in-charge information indicative of the program to be recorded by the respective nodes nn based on the regional information of the respective nodes nn. Therefore, it is possible to consider the region set up by the respective nodes nn and assign them as record in charge.

Further, because it is configured that the use record every content is acquired from the log server 2c, it is possible to reassign the record-in-charge information so that more nodes nn become in charge of record with respect to the program having higher viewing rate.

Further, according to the above-mentioned embodiment, even the two-hour program, the program is divided by a unit time (e.g. by 30 minutes or by one hour) and subject to be recorded and stored, published, and searched as a plurality of content data. However, they may be divided by program. For example, a title of the program inherent to the program and a code inherent to the program (e.g. G code) or the like are hashed with the same hash function as the node ID may be generated to generate the content ID.

Here, the record-in-charge information (record-in-charge program table (Refer to Table 1)) may be respectively divided by each program. Here, in a case where there is such a long program, such as 24-hour program, that a single node nn cannot record and store, a single program is divided not by program but by a plurality of recording time as explained in the above embodiment, a single program is recorded and stored by a plurality of nodes nn as a plurality of content data. The respective nodes nn in charge of record generate a content ID according to “time and date of already broadcasted program” and “broadcast channel” (i.e. recording start time and recording channel) and publish according to the content ID. When the respective nodes nn search the content, the respective nodes nn input a title or a G code of the desired program; the control unit 11 refers to a catalog list (where a program title, a program inherent code (e.g. G code) or the like are memorized in correspondence with “time and date of already broadcasted program” and “broadcast channel”) that is delivered from the registration server 2d, for example, by a system operator and memorized in the memory unit 12 and the above-mentioned catalog list that is published on the web by the system operator; generates a plurality of content IDs based on “time and date of already broadcasted program” and “broadcast channel” in correspondence with the title or G code of thus inputted program; and sends the plurality of content location inquiry messages. Therefore, it is possible that even a long program is recorded without fail by being shared among a plurality of nodes nn. Further, it is possible that the user trying to search the content searches all content data consisting of a single desired program at a time only by inputting a program title, a G code, or the like.

Further, although the library server 2g stores content data that are not encoded according to the above-mentioned embodiment, the library server 2g may receive content data encoded from respective nodes nn and store the encoded content data. Here, the node nn acquiring the content data encoded from the library server 2g inquires the node ID of the node nn originally storing the encoded content data (i.e. node nn being uploaded (sent) to the library server 2g to delete as a delete content data), and sends the node ID to the registration server 2d to acquire a public key of the node nn related to the node ID for decoding.

Further, the above-mentioned embodiment employs an asymmetric cipher key method that content data are encoded by a secret key and decoded by a public key. However, the content data may be encoded by a symmetric cipher key method to decrease a process load for decoding the encoded content data, and the asymmetric cipher key method may be employed when this key is delivered.

Further, when a new broadcast channel is opened, the registration server 2d sends new broadcast channel information to respective nodes nn. Accordingly, the respective nodes nn determine again a record-in-charge program by using a new broadcast channel number, and can deal with establishment of a new broadcast channel.

Further, a radio strength of receiving the broadcast channel is measured in respective nodes nn to judge whether or not this strength reaches a certain level (predetermined threshold). In a case where this strength does not reach the certain level, it may be configured that the node nn changes (updates) the record-in-charge program (a receiving strength judge means, a record-in-charge program updating means) Specifically, in a case where the node nn itself determines the record-in-charge program, the node nn redetermines the record-in-charge program except for the broadcast channel that does not reach the certain level of the radio strength. Further, in a case where the record-in-charge information is sent from the registration server 2d, it is responded to the registration server 2d that the broadcast channel not reaching the certain level of the radio strength cannot be recorded, and the record-in-charge information that is determined again by the registration server 2d is acquired. Accordingly, it is possible to record and store content data that keep a constant recording quality more than a certain level.

Further, according to the above-embodiment embodiment, the settlement server 2f receives a report of use record (Table 3) of the respective nodes nn from the log server 2e (S96). It is configured in such manner that an accounting process is carried out (an accounting process means) by using a number of sending a public key to respective nodes nn to be recorded in the registration server 2d (public key sending record (Table 2)). When the accounting process is carried out based on the use record reported from the log server 2e, it is checked against a public key sending record of the registration server 2d, thereby preventing occurrence of a mistaken settlement process.

Further, a plurality of servers function as a server device according to the present invention, in the above-mentioned embodiment. However, the registration server 2d carries out all of the log collection by the log server 2e, the management process, a settlement process by the settlement server 2f, and the process by the library server 2g for recording and storing the content data broadcasted in the past (content data deleted by the node nn). Accordingly, the registration server 2d may be caused to function as the server device according to the present invention.

Meanwhile, the above-mentioned content delivery system S may be applicable to video-on-demand-service type systems.

Moreover, the above-mentioned embodiment is explained on the premise of overlay network 9 configured by the algorithm using DHT. However, the present invention is not limited thereto.

The present invention is not confined to the configuration listed in the foregoing embodiments, but it is easily understood that the person skilled in the art can modify such configurations into various other modes, within the scope of the present invention described in the claims.

What is claimed is:

1. A node device included in an information delivery system that includes a plurality of node devices mutually communicable through a network and at least one or more broadcast stations broadcasting program information, the node device comprising:
a program information receiving means for receiving program information broadcasted respectively from the broadcast stations; and
a program information storage means for storing program information assigned as a record in charge among the program information thus received in correspondence with identification information inherent in the program information so that the program information is shared among the plurality of node devices.

2. The node device according to claim 1, further comprising:
a public message sending means for sending a public message that includes the identification information inherent in the program information thus stored to a node device that manages location of the program information to enable a common use among the plurality of node devices; and
a program information sending means for sending requested program information to other node device of a request source upon receipt of the request of the program information stored from the other node device.

3. The node device according to claim 2, further comprising:
an encode key memory means for memorizing an encode key inherent in the node device; and
an encoding means for encoding program information assigned as record in charge among the program information thus received by using the encode key thus memorized,
wherein the program information storage means stores the program information thus encoded in correspondence with the identification information, and the program information sending means sends the program information thus encoded to the other node device of the request source.

4. The node device according to claim 1, further comprising:
a participation registration means for registering to participate with respect to a server device that is included in the information delivery system at a time of participating in the information delivery system; and
a record-in-charge information acquisition means for acquiring record-in-charge information indicative of information related to the program information of record-in-charge which should be recorded by the own from the server device,
wherein the program information storage means stores program information assigned as record in charge based on the record-in-charge information.

5. The node device according to claim 4,
wherein the participation and registration means sends to the server device regional information indicative of a region where the node device is to be installed and carrying out participation and registration, and
the record-in-charge information acquisition means acquires the record-in-charge information determined based on the regional information from the server device.

6. The node device according to claim 4,
wherein the participation and registration means has a decode key sending means for sending a decode key for decoding information encoded by the encode key to the server device.

7. The node device according to claim 6, further comprising:
a search message sending means for sending a search message that includes the identification information inherent in the program information to a node device that manages a location of the program information in a case where the program information broadcasted in the past from any one of the broadcast stations is desired to acquire;
a node information acquisition means for acquiring node information that indicates the node device recording program information from a node device that manages a location of the program information;
a program information request means for requesting to send the program information to the node device recording the program information based on the node information;
a program information acquisition means for acquiring the encoded program information that is requested by the program information request means from the node device recording the program information;
a decode key request information sending means for sending, to the server device, decode key request information for requesting the decode key for decoding program information thus encoded;
a decode key acquisition means for acquiring the decode key from the server device; and
a decoding means for decoding the program information thus encoded by using the decode key thus acquired.

8. The node device according to claim 1, further comprising:
a receive strength judge means for measuring a receive strength of program information assigned as record in charge and judging whether or not the receive strength reaches a predetermined threshold; and
a record-in-charge program updating means for updating program information that is broadcasted from the broadcast stations other than the broadcast station that broadcasts the program information, as new program information for record in charge, in a case where the receive strength does not reach the predetermined threshold based on a result of the judgment.

9. A recording medium,
wherein a processing program is computer-readably recorded so as to be readable by a computer to cause a computer to function as the node device according to claim 1.

10. An information delivery system having a plurality of node devices mutually communicable through a network, at least one or more broadcast stations broadcasting program information, and a server device managing participation registration of the plurality of node devices, the respective node devices comprising:
a program information receiving means for receiving program information thus broadcasted from the respective broadcast stations;
a participation registration means for participating and registering with respect to the server device;
a record-in-charge information acquisition means for acquiring record-in-charge information that acquires information related to program information of record-in-charge to be recorded by the own from the server device; and
a program information storage means for storing the program information assigned as a record in charge, which is enabled to share among the plurality of node devices in correspondence with identification information inherent in the program information based on the record-in-charge information, out of the program information thus received, the server device comprising:
a record-in-charge information determination means for determining the record-in-charge information that indicates information related to the program information to be in charge of recording by the node device, upon receipt of the participation registration from the node device; and
a record-in-charge information sending means for sending the record-in-charge information thus determined to the node device.

11. The information delivery system according to claim 10,
wherein the participation registration means of the node device sends regional information indicative of a region where the node device is installed with respect to the server device, and the record-in-charge information determination means of the server device determines the record-in-charge information based on the regional information upon receipt of the regional information from the node device receiving the participation registration.

12. The information delivery system according to claim 10, wherein the node device further comprising:
an encode key memory means for memorizing an encode key inherent in the node device;
an encoding means for encoding program information assigned as a record in charge among program information thus received by using the encode key thus memorized, wherein the program information storage means stores the program information thus encoded in correspondence with the identification information;
a public message sending means for sending a public message including the identification information inherent in the program information thus stored to a node device managing location of the program information to thereby enable sharing among the plurality of node devices; and
a program information sending means for sending encoded program information that is requested to another request-source node device upon receipt of a request of the program information stored from the other node device,
wherein the participation registration means comprises a decode key sending means for sending a decode key to the server device for decoding information thus encoded by the encode key,
the server device, further comprising:
a decode key memory means for memorizing the node information indicative of the node device and the decode key in correspondence with each other upon receipt of the node information and the decode key from the node device; and
a decode key sending means for sending a decode key that is memorized by the decode key memory means in correspondence with the node information which is included in the decode key request information received to a request-source node device of the decode key upon receipt of decode key request information which requests the decode key necessary for decoding the program information from any one of the node devices, and
the node device desiring to acquire the program information comprising:
a search message sending means for sending a search message that includes the identification information inherent in the program information to a node device that manages a location of the program information;
a node information acquisition means for acquiring node information indicative of a node device which records the program information from a node device that manages a location of the program information;
a program information request means for requesting to send the program information to a node device recording the program information based on the node information thus acquired;
a program information acquisition means for acquiring the program information requested by the program information request means and thus decoded from a node device recording the program information;
a decode key request information sending means for sending, to the server device, decode key request information including the node information indicative of the node device which records the program information for requesting the decode key to decode program information thus encoded;
a decode key acquisition means for acquiring the decode key from the server device; and
a decoding means for decoding the program information thus encoded by using the decode key thus acquired.

13. The information delivery system according to claim 10, wherein the server device further comprising:
a user information management means for memorizing and managing user information respectively by each user of node device; and
an accounting process means for carrying out an accounting process to the user of the node device that sends the decode key request information.

14. The information delivery system according to claim 10,
wherein all pieces of the program information broadcasted from all the broadcast stations are divided and assigned to the plurality of node devices and stored by any one of the node devices.

15. A recording medium,
wherein a server processing program is recorded so as to be readable by a computer to thereby cause a single or plurality of computers to function as the server device according to claim 10.
